(19) United States
(12) Patent Application Publication
(10) Pub. No.: US 2009/0047000 A1
(43) Pub. Date: Feb. 19, 2009

(54) Method and Apparatus for a Web Browser-Based Multi-Channel Content Player

(75) Inventors: Robert J. Walikis, Irvine, CA (US); Edward D. Briscoe, St. Louis, MO (US); Mark M. Mihalevich, Brentwood, MO (US); Brad Herrick, Eureka, MO (US)

Correspondence Address: THOMPSON COBURN, LLP, ONE US BANK PLAZA, SUITE 3500, ST LOUIS, MO, 63101, US

(73) Assignee: VIBE SOLUTIONS GROUP, INC., St. Louis, MO (US)

(21) Appl. No.: 12/192,473

(22) Filed: Aug. 15, 2008

Related U.S. Application Data
(60) Provisional application No. 60/956,611, filed on Aug. 17, 2007.

(51) Int. Cl. H04N 7/26; G06F 17/00

(52) U.S. Cl. 386/124; 700/94

(57) ABSTRACT

A web-browser based content player capable of displaying audio and video is disclosed. The content player can play content titles that are organized into channels and user-configurable playlists. Users can navigate between titles, channels, and playlists within the player. The user can also purchase premium content from within the content player. The content player may be embedded in a host web page (e.g. of a social networking website).

### CROSS-REFERENCE AND PRIORITY CLAIM TO RELATED PATENT APPLICATION

This application claims priority to provisional patent application 60/956,611 filed Aug. 17, 2007, and entitled “Method and Apparatus for a Web Browser-Based Multi-Channel Content Player”, the entire disclosure of which is incorporated herein by reference.

### BACKGROUND AND SUMMARY OF THE INVENTION

The inventors herein disclose various embodiments for a web browser-based multi-channel content player.

A content player is a software object that is configured to display content to a user of a computer (e.g., a PC, laptop, handheld computing device (including a web-enabled telephone), web-enabled television, etc.). This software object can be stored on a computer-readable medium, for example a computer-readable storage medium such as computer memory (e.g., Random Access Memory (RAM)) or even a CD, DVD, etc. Through execution of its software code, the content player can issue calls to a remote server to trigger the delivery of content to the player for playback thereon. An example of content that can be displayed by a content player is multimedia content such as streaming audio/video or progressive audio/video download, as is well-known in the art. Individual content items (e.g., particular streaming or downloaded audio/video files) are referred to herein as a “titles” or “content titles”.

The content player disclosed by the inventors herein is configured with a variety of features. One of these features is that the content player be configured as a “web browser-based” content player. As used herein, the term “web browser-based” in the context of a content player means that a content player hosted on a remote server is configured to be accessed by any Internet-connected computer with an appropriately configured web browser resident thereon (e.g., Internet Explorer with the latest Flash player plug-in) such that the content player is presented to the user through that computer's web browser.

Another of these features is that the content player be configured as a “multi-channel” content player. As used herein, the term “channel” refers to a grouping of content titles. This concept is similar to that found in cable television wherein different cable television channels provide their own lineups of content titles (wherein, for traditional cable television, these content titles are broadcast at scheduled times). Thus, when the content player disclosed herein is said to be “multi-channel”, this means that a plurality of different channels can be accessed by a user from within the player. Each of these channels has an associated playlist, wherein each playlist comprises at least one title (and preferably a plurality of titles). The content player also provides users with the ability to navigate among the different titles of a channel playlist to play the desired title. Thus, not only does the multi-channel content player provide a user with the ability to navigate among multiple channels, but it also provides users with the ability to navigate among the different titles within each channel, all from within the player itself, and preferably in real time.

When it is said that actions are performed from “within the player”, this means that the user's input actions (including navigation actions), e.g., mouse clicks, keystrokes, scrolling, etc., are made while the screen cursor is inside the borders of the player or while the most recent click for the mouse was a click inside the borders of the player. For example, to perform channel-to-channel navigation and/or title-to-title navigation, the user need not take any input actions outside the borders of the content player. In instances where the player is displayed on a touchscreen, the user input actions would be touches by the user on the touchscreen within the border of the player.

Furthermore, the content player is preferably configured such that the lineup of channels is user-configurable from within the player. Further still, the content player is preferably configured such that the playlists for each channel are user-configurable from within the player. Through features such as these, users of such a content player can experience content viewing in a manner more flexible than available on traditional cable television (where channels and titles are only accessible via bundled packages, wherein these packages often include channels and titles of no interest to the user). With the content player described herein, however, users can personalize their players with channels and playlists that are specifically tuned to their interests.

Yet another of these features is that the content player be configured as an “embeddable” content player. As used herein, an “embeddable” content player refers to a content player that is configured such that it can be inserted within the viewable context of a web page as a result of an insertion of the code for the content player within the web page's software code. For example, users can insert the content player's software object code with a web page's software code to thereby embed the content player using any of a number of editing techniques made available to the user by the web service that hosts the web page. Preferably, the content player is embeddable on a full player basis, a channel-by-channel basis, and/or a title-by-title basis.

Yet another of these features is that the content player be configured to allow users to access channels and/or titles with different classifications (e.g., “free” and “premium” as explained hereinafter) by following different protocols from within the player. Various content packages, particularly premium content, can thus be made available through one time purchase/transaction, subscription purchase/transactions. Further still, from within the player, the user may be given the ability to control the classification that is assigned to various channels and/or titles. It should also be noted that a content publisher can also be given the ability to control the classification that is assigned to its channels and/or titles.

These and other features and advantages of the several embodiments of the invention will be described hereinafter to those having ordinary skill in the art.

### BRIEF DESCRIPTION OF THE DRAWINGS

FIG. 1 depicts an exemplary content player in accordance with an embodiment of the present invention;

FIG. 2 depicts an exemplary environment in which the content player is accessed by a user;

FIG. 3 depicts an exemplary content player including a channel selection list for changing the player's channel;

FIG. 4 depicts an exemplary content player including a title selection list for changing the title to be played by the player;

FIG. 5 depicts an exemplary embodiment for a content player that is configured to provide the user with the ability to add a channel to the player from within the player;

FIG. 6 depicts an exemplary user interface for display within the player through which a user can add a channel to the player;

FIG. 7 depicts an exemplary embodiment for a content player that is configured to provide the user with the ability to create a new channel for the player from within the player;

FIG. 8 depicts an exemplary user interface for display within the player through which a user can create a new channel for the player;

FIGS. 9(a) and (b) depict an exemplary content player that is configured to provide the user with access to the add channel and create new channel functions from a menu button included within the player's control panel;

FIG. 10 depicts an exemplary embodiment for a content player that is configured to provide the user with the ability to modify a playlist for a channel from within the player;

FIG. 11 depicts an exemplary user interface for display within the player through which a user can modify a channel's playlist;

FIGS. 12-16 depict an exemplary embodiment for a content player that is configured to provide the user with the ability to share the player on a full player basis, channel-by-channel, and a title-by-title basis;

FIG. 17 depicts an exemplary environment in which the content player is accessed by a user including a flow of calls between the content player and a remote server;

FIGS. 18-26 illustrate exemplary screenshots for various embodiments of the invention as described in Appendix A; and

FIGS. 27-66 illustrate exemplary screenshots for various embodiments of the invention as described in Appendix B.

### DETAILED DESCRIPTION OF THE PREFERRED EMBODIMENTS

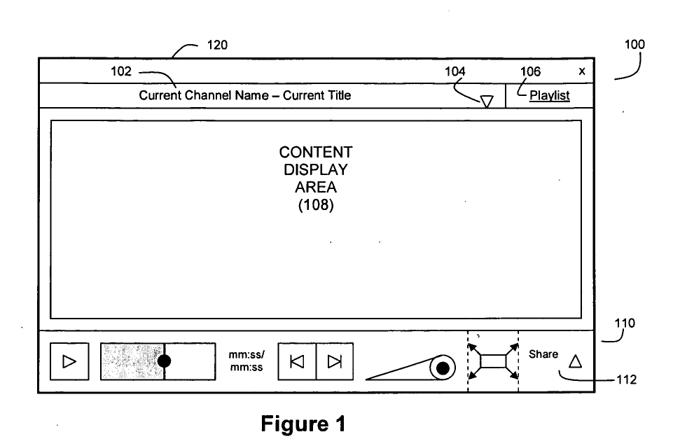

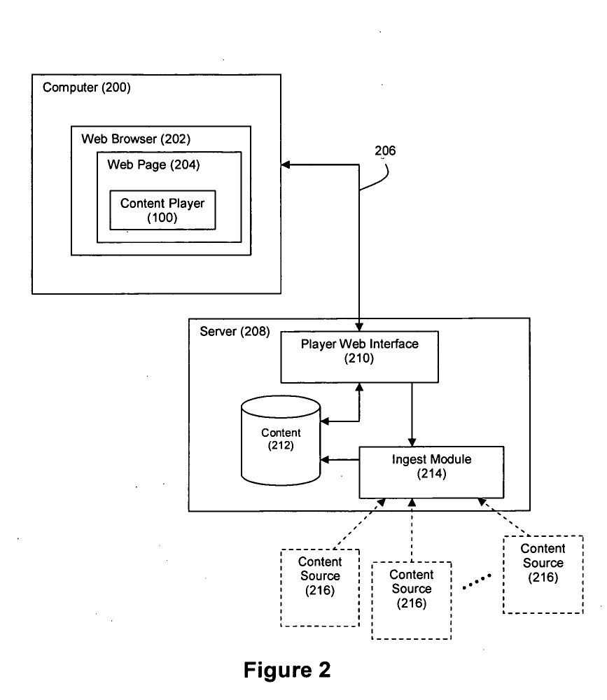

FIG. 1 depicts an exemplary content player 100 in accordance with an embodiment of the present invention. FIG. 2 depicts an exemplary environment in which the content player 100 is accessed by a user.

As shown in FIG. 2, a user of computer 200 can access a web page 204 through the computer's web browser 202. Web page 204 has content player 100 embedded therein, as explained hereinafter. Through the content player 100, a user can connect to a remote server 208 over the Internet 206. This remote server 208 can provide content to the content player 100 from a content database 212 (via a software module 210 that serves as a content player-to-web interface). In response to user interaction through player 100, a user can then view the content provided by server 208. Furthermore, server 208 can optionally communicate with one or more content sources 216 to obtain content for storage in database 212. An ingest module 214 can prepare the content received from content sources 216 (or optionally from the computer 200) for storage in database 212 and subsequent playback through player 100. Further still, the server 208 is preferably configured to automatically update the playlists for each channel as new content for those channels are received from different content source feeds.

As shown in FIG. 1, the content player 100 includes a content display area 108 through which titles are presented during playback to the user. Border 120 defines the border for player 100. A control panel 110 is also present within the player 100 for receiving user input to control the manner of playback (e.g., a play/pause button for playing/pausing content, a time marker to show the progress of content playback, title skip buttons, volume control, and screen size controls (e.g., full screen mode, fit-to-player mode, original size mode)). It should be noted that, when in full-screen mode, the full-screen display preferably retains section 102 and buttons 104 and 106 to provide the user with the ability to navigate among channels and/or titles without exiting from the full screen mode. Control panel 110 can also include a share button 112, as described hereinafter.

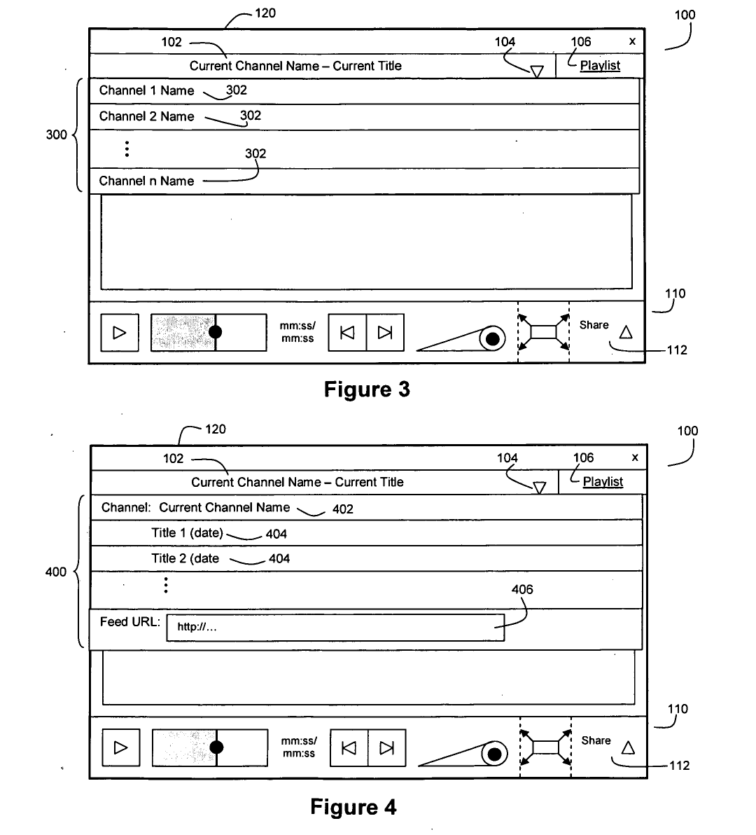

The name of the current channel for the player 100 is displayed in section 102 as is the name of the current title within the current channel. To navigate to other channels for the player from within the player, the user can select button 104. In response to selection of button 104 within player 100, a list 300 of user-selectable channels 302 will be displayed within the player, as shown in FIG. 3. To change the channel for the player, the user can select one of the listed channels 302.

However, it should be noted that the protocol for accessing a channel can vary as a function of a classification assigned to each channel. Examples of such channel classifications can include “free” channels and “premium” channels. Preferably “free” channels can be readily accessed by the player without further user input after selection of the free channel from list 300. However, for “premium” channels, additional steps are preferably required to authenticate that the user has authorization to access those channels, as explained hereinafter. A “premium” channel is defined as a channel which restricts access thereto only to authorized users. A premium channel can require a user subscription (optionally a paid user subscription) before allowing user access. Alternatively, other manners for restricting access can be implemented, such as requiring that the user obtain permission to access the premium channel from a channel administrator. It should be noted that the content player is preferably configured to allow the user to complete all necessary protocols for accessing any channel from within the player itself. Appendix A included herewith describes an exemplary protocol for accessing a premium channel from within the player.

Returning to FIG. 1, to display the playlist of titles for the current channel, the user can select the playlist button 106. In response to selection of button 106 within player 100, a list 400 of user-selectable titles 404 within the current channel 402 will be displayed within the player, as shown in FIG. 4. To change the title to be displayed by the player, the user need only select one of the listed titles 404. List 400 also preferably identifies a URL in field 406 that is associated with the current channel 402. In many instances, a content source 216 will operate to feed the titles for channel 402 to the server 208. Field 406 will identify a URL to which a user could access the content for channel 402 directly from its source 216.

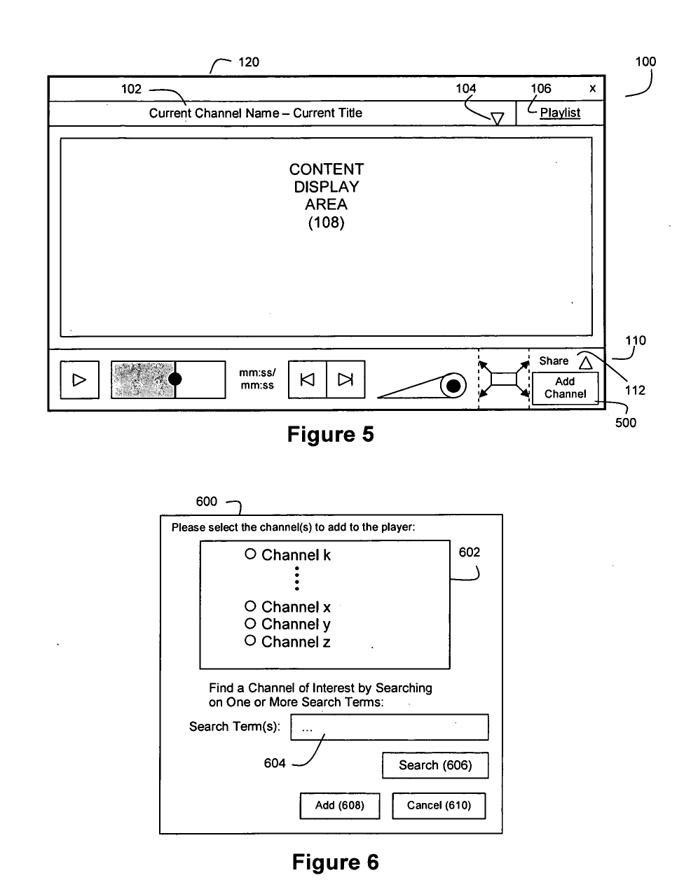

It should be noted that content player 100 is preferably configured to provide the user with the ability to configure the player's channel lineup from within the player. FIG. 5 depicts an exemplary embodiment for a content player 100 that is configured to provide the user with the ability to add a channel to the player from within the player. To initiate adding a channel to the player, the user can select button 500, as shown in FIG. 5. Upon selection of button 500, a user interface menu 600 such as the one shown in FIG. 6 can be displayed within the player, preferably as an overlay that is superimposed over display area 108. Menu 600 is configured to provide the user with a list 602 of selectable options for existing channels (e.g., channels available from server 208) for adding to the player 100. Preferably, menu 600 is configured to allow the user to select one or more channels for addition to the player at the same time. Menu 600 can also be configured with a search feature that allows users to search for channels of interest. For example, menu 600 is configured with a field 604 in which the user can enter one or more search terms. Upon selection of search button 608, the list 602 can be augmented or replaced with a list of channels that satisfies the user-specified search criteria. To add selected channels to the player, the user can select button 608. To cancel the channel addition operation, the user can select button 610.

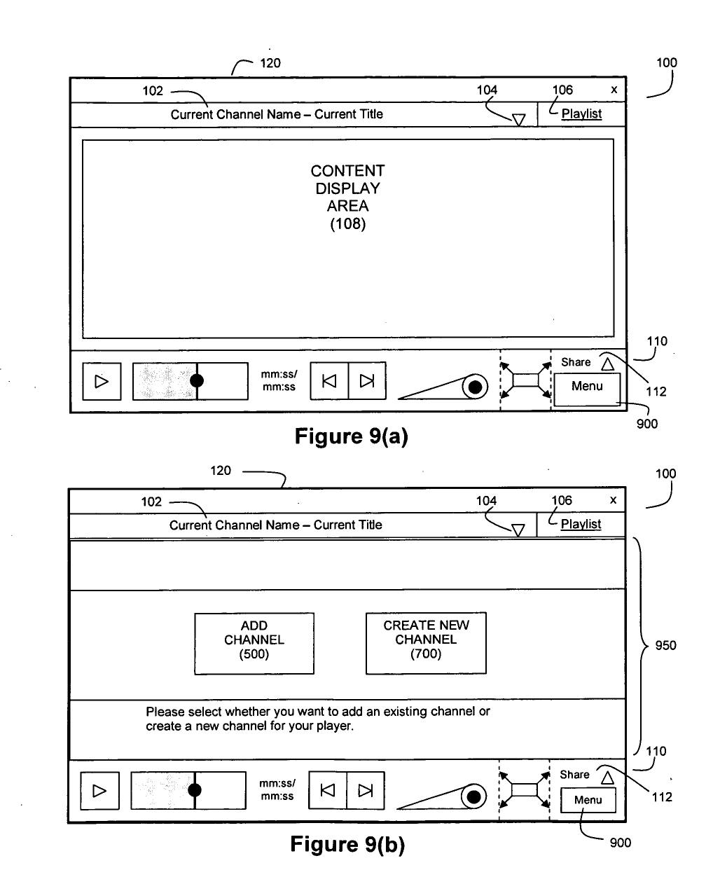

It should also be noted that a practitioner of this embodiment of the invention may choose to place the channel add button 500 at locations within the player 100 different than that shown in FIG. 5. For example, the channel add button 500 could also be located somewhere on list 300 that is displayed in response to user selection of button 104 (see also FIGS. 9(a) and (b)).

It should also be noted that the protocol for adding a channel to a player can vary as a function of the classification assigned to each channel, wherein similar restrictions to adding channels are in place as are used for accessing channels.

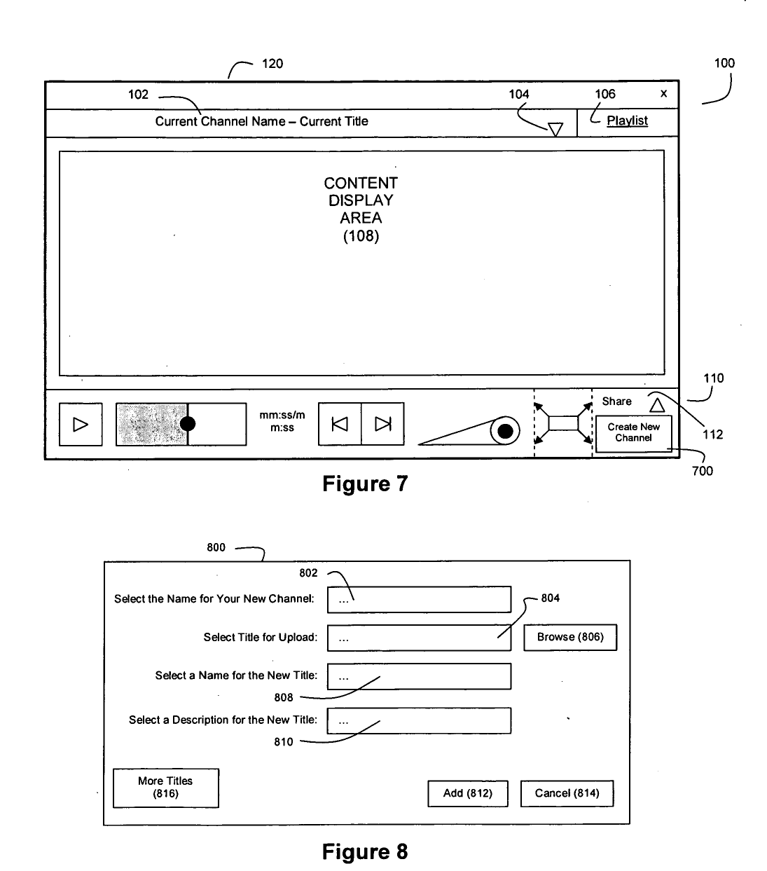

FIG. 7 depicts an exemplary embodiment for a content player 100 that is configured to provide the user with the ability to create a new channel for the player from within the player. To initiate creating a new channel for the player, the user can select button 700, as shown in FIG. 7. Upon selection of button 700, a user interface 800 such as the one shown in FIG. 8 can be displayed within the player, preferably as an overlay that is superimposed over display area 108. User interface 800 is configured to provide the user with a field 802 in which the user can specify a name for the new channel. Through field 804, the user can specify a title that is to be added to the new channel. A button 806 can be provided for the user to select for browsing through titles that are saved in memory on computer 200. Furthermore, through such a browsing feature, a user can also be given the opportunity to browse through the titles stored on server 208 within the various channels. In this manner, a user can configure the new channel not only with his/her own content from his/her own computer but also content available from server 208 but through a different channel. Similar restrictions and protocols can be used as described above to prevent a user from gaining unauthorized access to titles within premium channels.

User interface 800 also preferably includes a field 808 in which the user can provide a name for the title to be added, wherein this name is the name that will appear for the title in playlist menu 400. Further still, user interface 800 also preferably includes a field 810 in which the user can provide a description for the new title. Such a description can be used to aid any searching processes whereby users can search for titles of interest.

To add additional fields 804, 808, and 810 to user interface 800 for adding multiple titles to the new channel, the user can select button 816. Otherwise, if the user has specified the name of the channel to be added and any content titles to be included in the playlist for the new channel, the user can add the new channel and any accompanying titles to the player by selecting the add button 812. Selection of button 812 will invoke a corresponding process on server 208 to add the new channel and any accompanying titles to the server's storage for subsequent real-time access to the new channel. If the user does not wish to add the new channel, he/she can select the cancel button 814.

Such a new channel that is created by a user can be termed a “personal” channel. Thus, another channel classification that can be used by the player for channels is a “personal” channel, wherein a “personal” channel is defined as a channel that is user-created. An example of a personal channel would be a “My Summer Vacation” channel created by a user, wherein the user has populated the playlist for the “My Summer Vacation” channel with video clips from that user's summer vacation. Another example of a personal channel would be “My Favorite Titles” channel, wherein the user has populated the playlist for the “My Favorite Titles” channel with various titles, either user-created titles, titles selected from other channels to which the user has access, or some combination thereof. Preferably, the content player 100 (or the website associated with server 208) is configured to provide the user who creates a personal channel with the ability through user interface 800 or other means to designate the personal channel with a “free” classification or a “premium” classification, wherein this classification will control how users would access such a personal channel. When designating a personal channel as a premium channel, the player (or the website associated with server 208) is preferably configured to provide the user with the ability to define the conditions under which users will be given access to the personal premium channel. For example, the creator of the personal channel can be given an option to designate that a monetary fee must be collected from a user before providing such a user with access to the personal premium channel (e.g., a monthly subscription at $X/month, a $Y per access fee, etc.). The server 208 can include payment mechanisms accessible from within the player that allow a user to pay for access to personal premium channels (or premium channels generally) as desired by that user. Further still, the creator of the personal channel can be given an option to designate that only a user invited by the creator be allowed to access the personal premium channel. Further still, the creator of the personal channel can be given an option to simply set up a user name and password which must be supplied by a user to access the personal premium channel. Moreover, the creator of the personal channel can be given an option as to whether a personal channel (whether it be free or premium) is to be listed publicly on the channel menu 602 shown in FIG. 6. These options can be provided to the user through user interface 800 or another user interface that is preferably accessible and displayed through the player.

Further still, it is worth noting that the “free” and “premium” classifications can also be applied on a title-by-title basis in addition to or rather than a channel-by-channel basis. The protocols for accessing and adding “premium” titles to a channel can operate as those described in connection with premium channels, albeit for titles rather than channels. Optionally, the user can specify whether user-created titles are to be classified as “free” or “premium” (or “same as channel” wherein the title's classification would follow whatever classification has been assigned to the channel within which the title resides) through a user entry field or the like displayed on a user interface such as user interface 800.

It should also be noted that a practitioner of this embodiment of the invention may choose to place the create new channel button 700 at locations within the player 100 different than that shown in FIG. 7. For example, the create new channel button 700 could also be located somewhere on list 300 that is displayed in response to user selection of button 104. Further still, the create new channel button 700 can be placed on the player 100 near the add channel button 500. Further yet, the control panel 110 of player 100 can be configured with a “menu” button 900 as shown in FIG. 9(a). Upon selection of button 900, the player displays section 950, which includes button 500 and 700, as shown in FIG. 9(b). Further still, the create new channel button 700 can be nested within the add channel process by locating the create new channel button within the user interface menu 600.

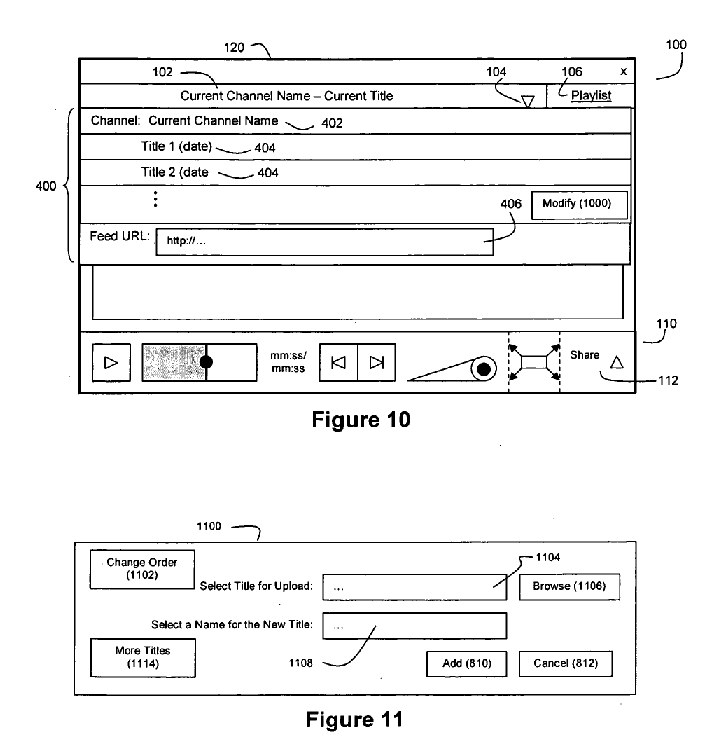

Users are also preferably given the ability to modify playlists from within the player 100. An example of this is shown in FIG. 10, wherein a modify playlist button 1000 is included for user selection within playlist menu 400. In response to user selection of the modify playlist button 1000, the user interface 1100 of FIG. 11 can be displayed within the player, preferably as an overlay that is superimposed over display area 108. Fields 1104 and 1108 together with “browse” button 1106 and “more titles” button 1104 preferably operate to add one or more titles to the playlist as described above in connection with fields 804, 808 and buttons 806 and 814 for adding titles to channels. Furthermore, user interface 1100 can also include a button that allows the user to re-order the titles within a playlist.

It should be noted that the modify button 1000 may optionally be placed in other locations within the player. For example, the modify button 1000 could also be included as a button that is presented to the user within section 950 of FIG. 9(b) in response to selection of the menu button 900 of FIG. 9(a).

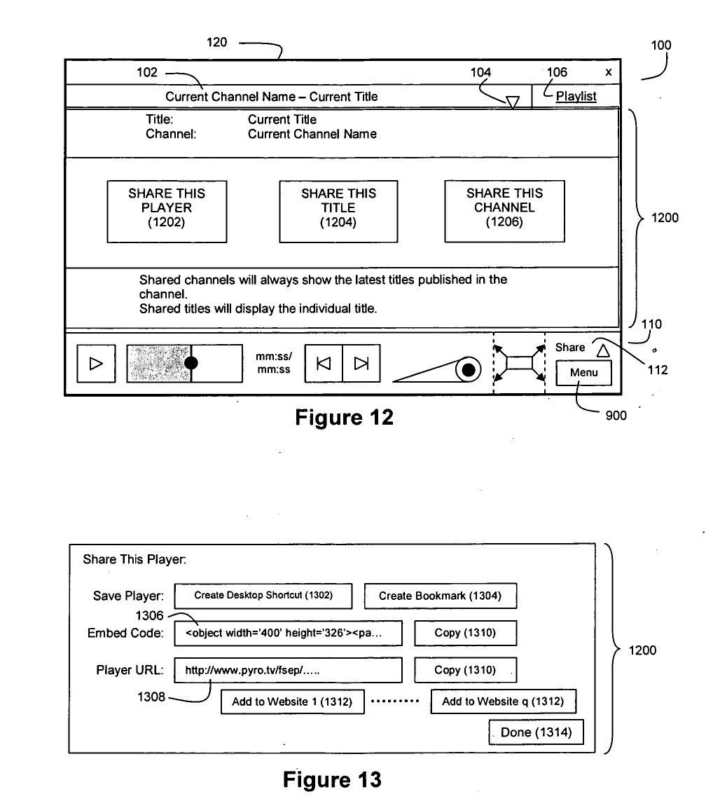

Furthermore, through the player's share button 112, a user can share the player (or portions of the player) on a full player basis, a channel-by-channel basis or a title-by-title basis. In response to user selection of the share button 112, section 1200 of FIG. 12 can be displayed within the player, preferably as an overlay that is superimposed over display area 108. The player of FIG. 12 includes options for sharing the player, sharing channels, and sharing titles within section 1200. By selecting the “share this player” button 1202, the user can initiate the process of sharing the player itself. By selecting the “share this title” button 1204, the user can initiate the process of sharing the current title for the player. By selecting the “share this channel” button 1206, the user can initiate the process of sharing the current channel for the player.

In response to user selection of button 1202, section 1200 of the player would be populated as shown in FIG. 13. Through section 1200 of FIG. 13, a user can initiate such actions as saving the content player 100 to a computer for access through a desktop icon (via user selection of button 1302) and creating a bookmark to the to the content player as a directly accessible web page (via user selection of button 1304).

Furthermore, section 1200 of FIG. 13, a user can obtain a copy of an embed code 1306 for the content player 100. Preferably, section 1200 of FIG. 13 also displays this embed code 1306, as shown in FIG. 13. The user can obtain a copy of the embed code 1306 for the player via user selection of button 1310, which is effective to automatically copy the embed code 1306 to a notepad memory or the like for computer 200, thereby enabling the user to paste the embed code to another location (e.g., a different web page such as a web page on a blogging website, a web page on social networking website, a personal profile within any software service (messaging, storage, communications, community, content viewing, discussion, bookmarking) website, etc. The user could also obtain a copy of the embed code 1306 by mousing over the embed code 1306 and using well-known keystroke commands and/or mouse clicks to copy the code 1306 to notepad memory. The embed code 1306 serves to encapsulate the required, optional, and/or browser-specific software code and configuration parameters required for a plurality (preferably all) of standards-based and plug-in supported web browsers to display the viewable and actionable (i.e., a user interaction with the content player) content player within a web page. Thus, by pasting the embed code onto a web page for a website such as a blogging website or a social networking website, the user can easily embed content player 100, including all of the channel lineups and playlists accessible therethrough, to a new web location through which it can be accessed via a web browser.

Section 1200 of FIG. 13 also preferably provides the user with the ability to obtain a copy of a URL 1308 for the player 100. This player URL points to a location on a server which hosts a copy of the content player 100 (e.g., a web page on server 208). The same mechanisms for obtaining a copy of the embed code can also be employed by the user to obtain a copy of the player URL 1308 (including a button 1310 for automatically copying the player URL to a notepad memory). With a copy of the player URL, a user can easily paste a direct link to the content player in another location (e.g., an email, another webpage, etc.).

Furthermore, section 1200 of FIG. 13 may also include one or more user-selectable buttons that are configured to cause the content player to be embedded to a (1) personal or public web page or web log (blog), and/or (2) personal or public profile within a social networking web service, wherein these locations typically require log-in and/or an active target site session-cookie to facilitate secure access to specified web site target pages.

Once a user has completed his/her actions within section 1200 of FIG. 13, then he/she can select the done button 1314 to return the player 100 to its normal display configuration.

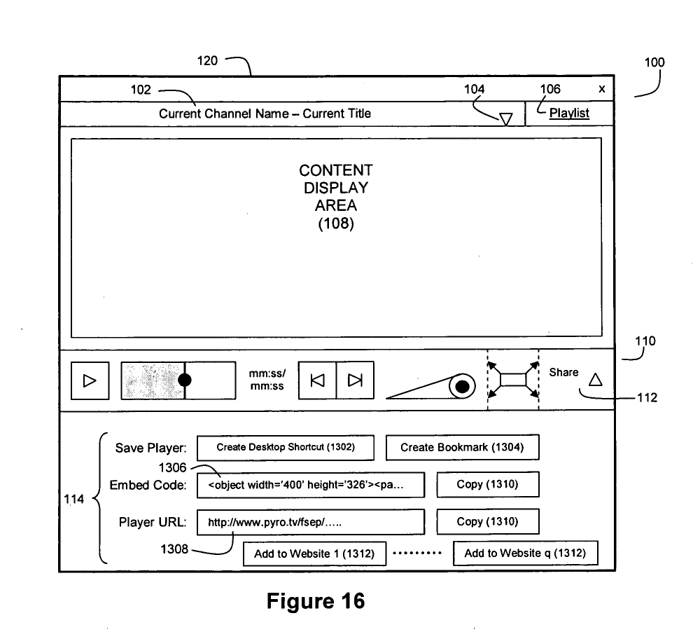

Thus, section 1200 of FIG. 13 provides the user with an efficient means by which to share the content player with other people and distribute the content player to different locations on the Internet. It should also be noted that the player 100 may optionally be configured such that section 1200 of FIG. 13 is included as section 114 within the player 100, as shown in FIG. 16. In such a player configuration, the section 1200 of FIG. 12 need not include the “share this player” button 1202. Further still, a “share this player” button 1202 may optionally be included as its own button within control panel 110 of the player. Further yet, the “share this player” button (or section 114) can be displayed within content display area 108 through overlays that are initially displayed (prior to play), interstitially displayed (between transitions in titles or channels), and/or during content playback (via mouseover actions while a title is playing).

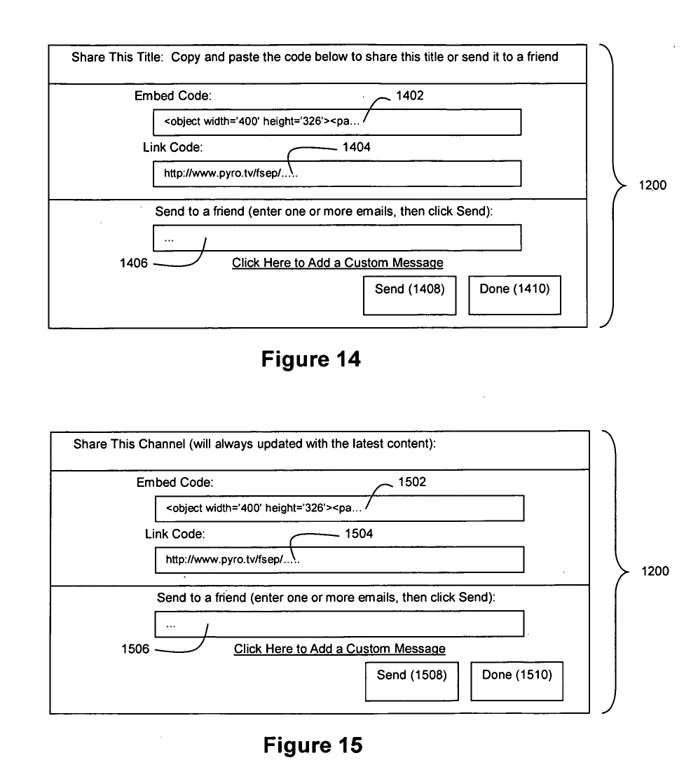

In response to user selection of button 1204, section 1200 of the player would be populated as shown in FIG. 14. Section 1200 of FIG. 14 includes fields with an embed code 1402 and URL link code 1404 which are analogous to the embed code 1306 and player URL 1308 previously described. However, it should be noted that the embed code 1402 is configured such that the parameters for the embed code 1402 restrict the player to the current title (rather than being an embed code 1308, which pertains to the full player). Similarly, the link URL code 1404 for the player is configured to limit the link to only the title to be shared. These codes 1402 and 1404 can be copied to a notepad memory as described above in connection with codes 1306 and 1308. Further still, copy buttons can also be included in section 1200 to automate the copying process. Furthermore, field 1406 within section 1200 of FIG. 14 is preferably configured to allow the user to enter email addresses of desired recipients for the player's title URL. To send an email to the desired recipients, the user can thereafter select the send button 1408. Otherwise, the user can select the “done” button 1410.

In response to user selection of button 1206 shown in FIG. 12, section 1200 of the player would be populated as shown in FIG. 15. Section 1200 of FIG. 15 includes fields with an embed code 1502 and URL link code 1504 which are analogous to the embed codes 1306/1402 and URLs 1308/1404 previously described. However, it should be noted that the embed code 1502 is configured such that the parameters for the embed code 1502 restrict the player to the current channel (rather than being an embed code 1306, which pertains to the full player, or being an embed code 1402 that is restricted to a particular title). Similarly, the link URL code 1504 for the player is configured to limit the link to only the channel to be shared. These codes 1502 and 1504 can be copied to a notepad memory as described above in connection with codes 1306 and 1308. Further still, copy buttons can also be included in section 1200 to automate the copying process. Furthermore, field 1506 within section 1200 of FIG. 15 is preferably configured to allow the user to enter email addresses of desired recipients for the player's title URL. To send an email to the desired recipients, the user can thereafter select the send button 1508. Otherwise, the user can select the done button 1510.

Thus, through controls provided within the player itself, the user can obtain an embed code and/or a URL code for the player that is specific as to any of the full player, a particular channel within the player, and a particular title within the player. In this manner, user are given great flexibility in controlling how their customizable players can be shared with others.

Additional details regarding the player 100 are provided herewith in Appendix B.

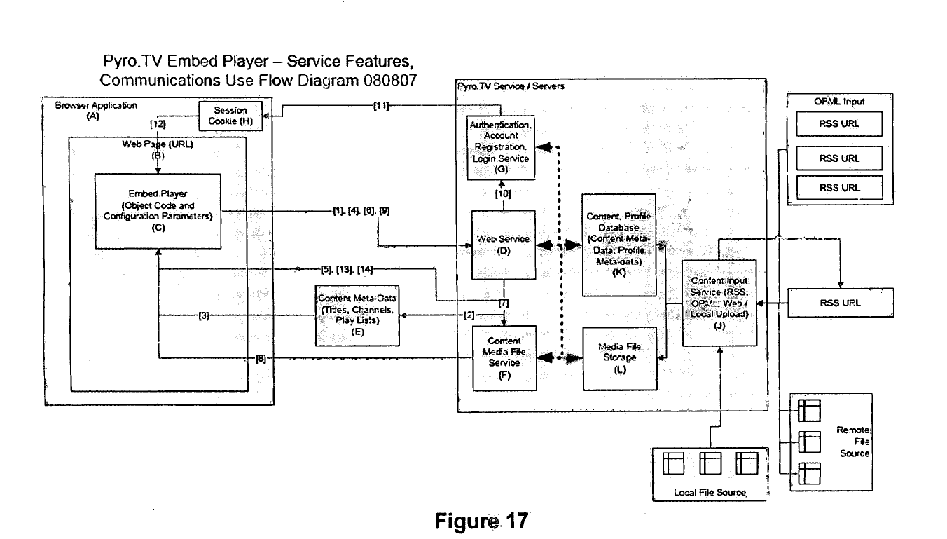

Furthermore, additional details regarding the interaction between an embedded web browser-based content player 100 and its associated server 208 are shown in Appendix C with reference to FIG. 17.

While the present invention has been described above in relation to its preferred embodiment, such description is intended to be merely illustrative of the invention and various modifications may be made thereto that still fall within the invention's scope, as would be recognized by those of ordinary skill in the art upon review of the teachings herein. In view of such exemplary modifications, the full scope of the present invention is to be defined solely by the appended claims and their legal equivalents.

### APPENDIX A

### Player Authentication Requirements

### Overview

This document specifies exemplary requirements for enabling authentication of users at the player level. In other words, regardless of where the player exists, we can authenticate a user so that certain channels can be enabled for that user.

### General Requirements

Channels can be authenticated for playback of premium channels.
Premium channels are only viewable by the authorized accounts.
Free channels are available to any viewer.
When a viewer attempts to view a premium channel, the user will be prompted for a username & password unless valid cookie is present or they are already logged in.
Option will exist to “Keep me logged in on this computer”, which will create a cookie.
If logged in but not subscribed, user will be prompted to subscribe.
Same cookie behavior for Pyro.TV will be used for the player.

### Detailed Requirements

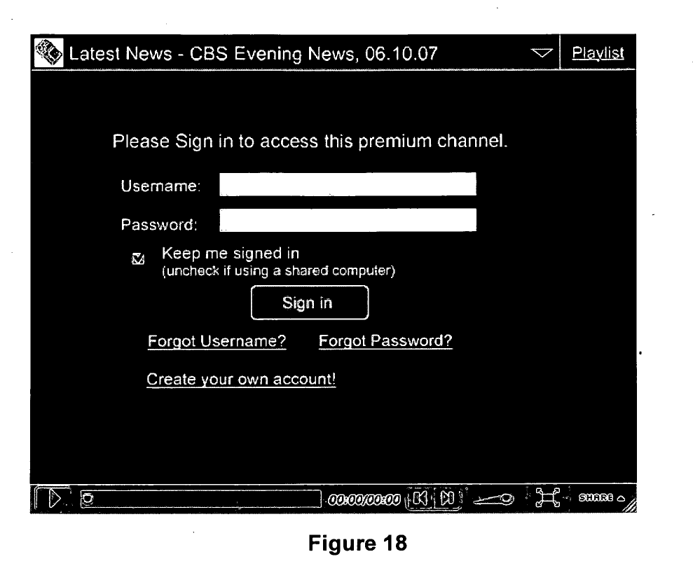

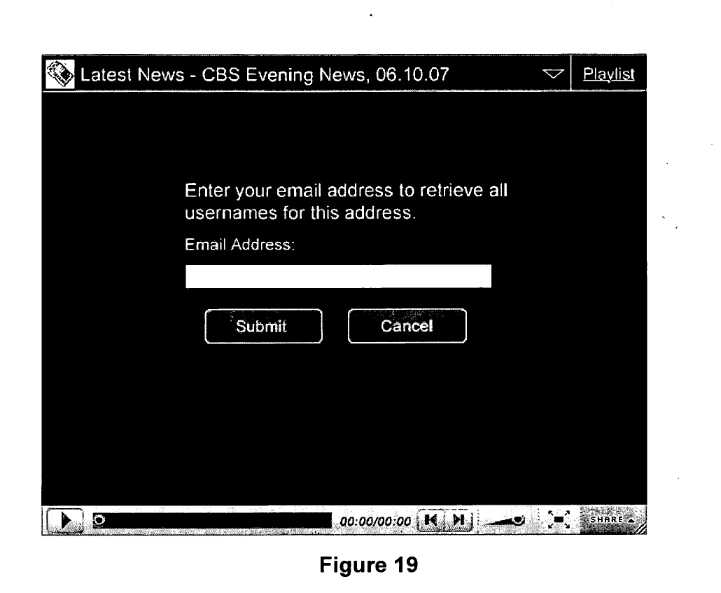

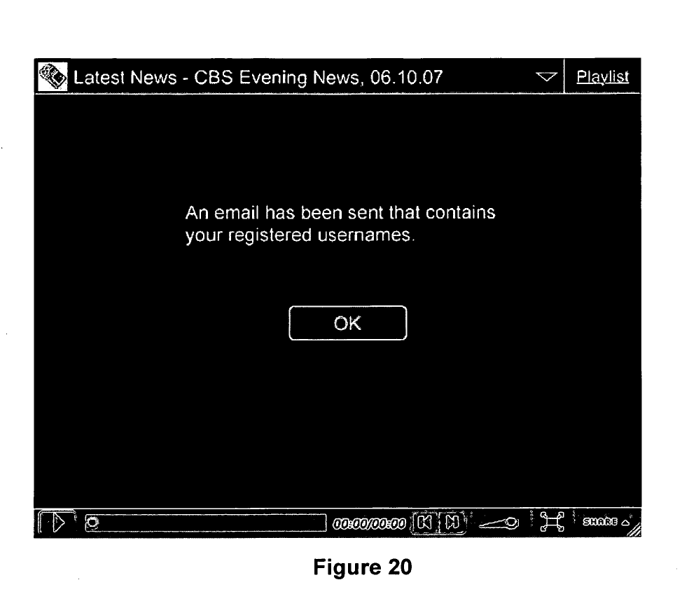

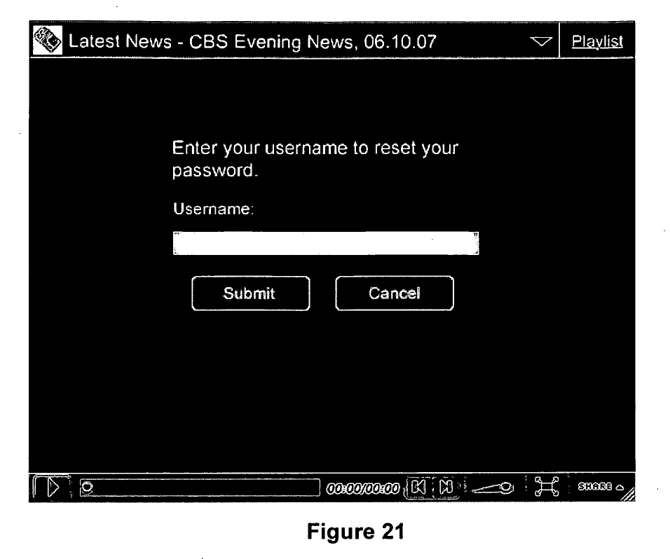

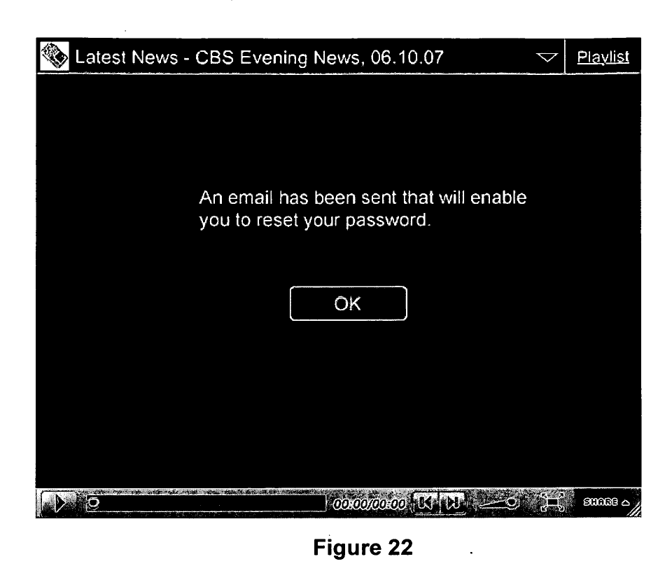

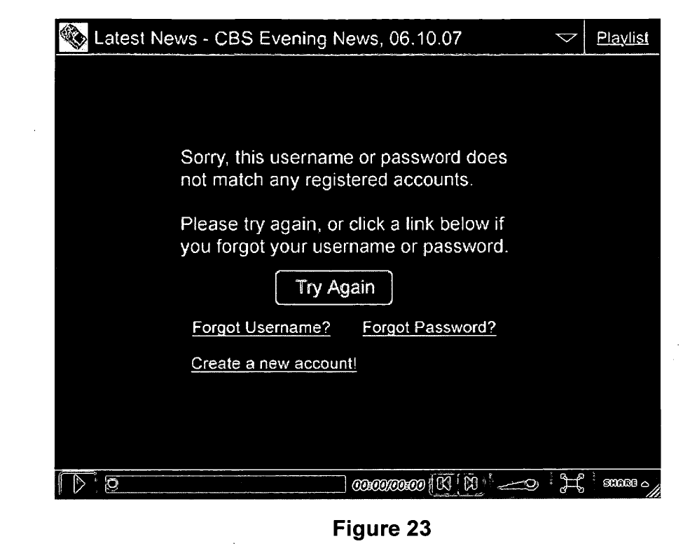

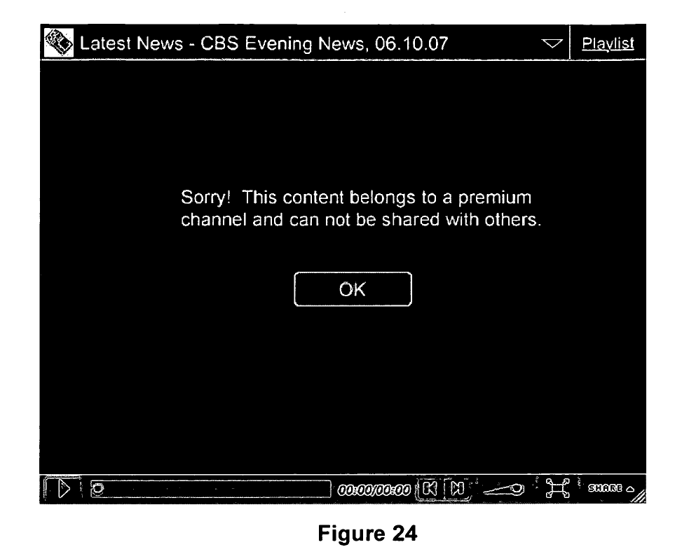

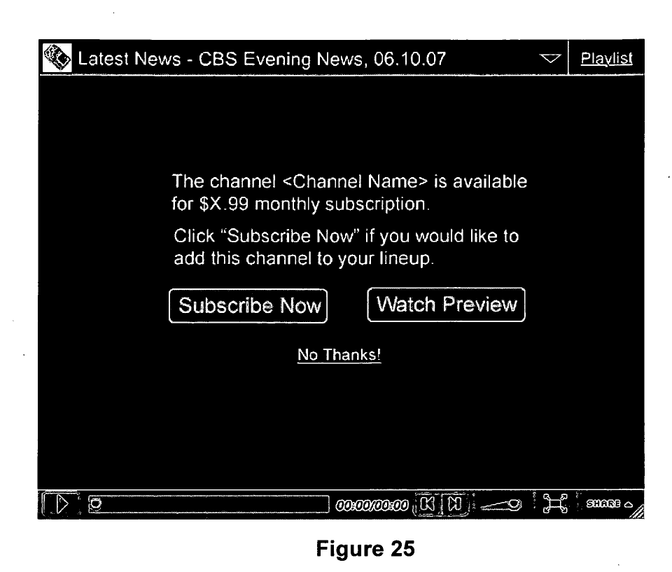

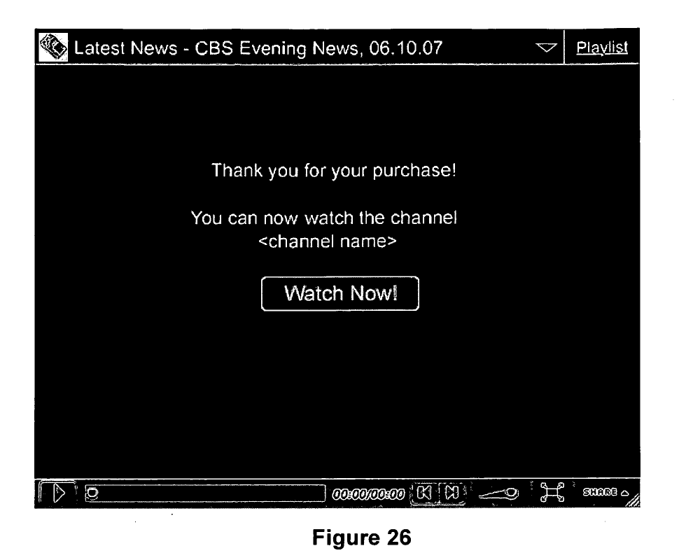

1. Players can be authenticated for playback of premium channels.
   a. To offer premium channel through the player and still allow the player to be embedded into any site, we must be able to authenticate a user at the point of viewing the content in the player.
   b. When a viewer attempts to view a premium channel, an semi-transparent overlay will appear (see FIG. 18) with the following;
      i. Text field for username
      ii. Text field for password
      iii. Option to “Keep me signed in”, which will be default to on
      iv. Forgot Username?
      v. Forgot Password?
      vi. Create your own account!
   c. Username and Password will authenticate against the Pyro.TV and partner account database
   d. The option to “Keep me signed in” (on be default), will add a cookie to the user's PC.
      i. The configuration of this cookie should be identical to Pyro.TV
      ii. Ideally the same cookie used for Pyro.TV should work for the Embedded Player (in other words, if the option to “Keep me signed in” was already selected in Pyro.TV, that should be seen as a valid cookie for the player as well.
   e. “Sign in” submits the entries.
   f. “Forgot Username?” Will direct the user to a new overlay, shown in FIG. 19.
      i. Functionally, forgot username will work the same way it does in Pyro.TV
      ii. User will enter an email address
      iii. User click “Submit”
      iv. A confirmation of email is displayed (FIG. 20)
      v. All accounts registered to that address will be sent via and email to user.
      vi. If user clicks “Cancel”, the user will be returned to the sign in page.
      vii. When user clicks “OK” the user will be returned to the sign in page.
   g. “Forgot Password?” will direct the user to a new overlay, shown in FIG. 21.
      i. Functions the same as Forgot Password in Pyro.TV
      ii. User enters the username.
      iii. User clicks “Submit”
      iv. If user clicks “Cancel” the user is returned to the Sign in page.
      v. Confirmation of sent email is displayed (FIG. 22)
      vi. User clicks “OK”
      vii. User is returned to Sign in page.
   h. “Create your own account!” will direct the user the appropriate partner account registration page.
      i. In the case of Pyro.TV, the user will be directed to Pyro.TV with the account registration window open.
   i. Incorrect Username or Password
      i. If the user enters an incorrect username or password, the user will be directed to an overlay, as shown in FIG. 23.
      ii. “Try Again” will return the user to the Sign in page.
      iii. “Forgot Username?” will function as described in section 1f.
      iv. “Forgot Password?” will function as described in section 1g.
      v. ‘Create a new account!” will function as described in section 1h.
   j. Exiting account sign in process.
      i. At any point in the useflows specified in section 1, the user navigates to a new channel, the user will exit the sign in process and return to viewing video.
      ii. If the user navigates to another premium channels, the user will be returned to the sign in page.
   k. Attempting to share premium content:
      i. If the user chooses the option to share while in the sign in process, or while viewing a premium channel, the user will be shown FIG. 24.
      ii. Clicking “OK” will return the user to the sign in page (if not signed in) or to viewing the content if signed in.
2. Signed in users will be checked as authorized or not to view specific premium channels.
   a. If user is authorized to view a channel, channel will play and all titles in the channel can be browsed and viewed.
   b. If user is not authorized to view a channel, a message will display indicating that a subscription is required to view the channel, including the following options: (as shown in FIG. 25)
      i. Subscribe Now
      ii. Watch Preview
      iii. No Thanks
   c. The text will display the channel name (indicated in FIG. 25 as <Channel Name> and the Price (indicated in FIG. 25 as $X.99).
   d. “Subscribe Now” will perform one of the following 2 actions:
      i. If user's account has billing information already established, the following confirmation screen will display (FIG. 26).
      ii. If a user's account does not have billing information established, the user will be linked to the billing entry page for their account on Pyro.TV (url TBD).
   e. “Watch Preview” will play the channel preview.
      i. After completion of the preview, display will return to subscription page (FIG. 25)
   f. “No Thanks!” will return the player to the start screen for the player.
   g. Confirmation screen will display a thank you message, including the name of the channel, indicated in FIG. 26 as <channel name>
      i. “Watch Now!” will begin playing the subscribed channel at the first video.

### APPENDIX B

### Pyro.TV Embeddable Flash Players PRD

The Pyro.TV Embeddable Flash Players PRD is intended to provide exemplary requirements and exemplary use flow details for:
1) insertion of an Embedded Title Flash Player into web pages
Access to Title embed/link code from within
   Pyro.TV (Partner TV) Video Player Window,
   Embedded Title Players,
   Embedded Channel Players,
   Embedded My Channel Players,
   Search API
Option to Share Title or Channel of Title
   2) insertion of an Embedded Channel Flash Player into web pages
Access to Channel embed/link code from within
   Pyro.TV (Partner TV) Video Player Window,
   Pyro.TV (Partner TV) Channel Info/View Titles Page
   Pyro.TV (Partner TV) Created Channels Tab
   Embedded Title Players
   Embedded Channel Players
   Embedded My Channel Players
   Search API
Option to Share Title or Channel of Title
   3) insertion of an Embedded My Channels Flash Player into web pages
Access to My Channels embed/link code from within
   Pyro.TV (Partner TV) My Channels Tab
   Embedded My Channel Players
Option to Share Title or Channel of Title
   4) Embeddable Players can be configured to work properly in major social network/web sites, including the following validated/required sites such as:
My Space
Friendster
Multiply
Vibe Journal & Partner Journal
Blogger
TypePad
Yahoo! 360
Windows Live Spaces

### 1) Embeddable Title Flash Player

A) Skinning
   1) No partner TV or content partner skinning
   2) Pyro.TV embeddable player skin common across all Partner TV implementations
   3) Title Description, Channel Title, Channel Logo shown within Mouseover Title Bar feature when video is playing.
   4) Prior to and after video play, present slightly transparent overlay of video window showing first frame of video, to include:
      Channel Logo, clickable back to “View Titles” in Tab Window, playing first video in channel in Video Player Window
      Channel Title
      “By [Publisher/Author]”
      “[Title Description]—[Published Date]”
      “Click to Play Video”, clickable to start video title playing
      “Click to see more titles from this channel”, clickable back to “View Titles” in Tab Window, playing first video in channel in Video Player Window
      “Powered by [Pyro.TV logo]”, clickable back to Pyro.TV site at http://www.pyro.tv/
      3) Title Description, Channel Title, Channel Logo shown within
B) Backend
   1) Embedded Title Players will require VSG Backend to save and continue to serve Title after imported feed/VSG cache no longer contains Title
   2) Active Title Expiration Rules: Active Embedded Titles configurable for automatic deletion
      A) Never
      B) After X months from creation date
      C) after non-viewing for Y months
      D) After X months from creation date AND after non-viewing for Y months
      E) After X months from creation date OR after non-viewing for Y months

| | CreateLimit | NonViewLimit | Min/Max |
|---|---|---|---|
| Never expire | | | Max |
| After X months | X | | Max |
| from create | | | |
| date | | | |
| After Y months | | Y | Max |
| non-viewing | | | |
| After X months | X | Y | Max |
| from create AND | | | |
| Y months from | | | |
| non-view | | | |
| After X months | X | Y | Min |
| from create OR | | | |
| Y months from | | | |
| non-view | | | |

3) Active Embedded Title data (title/embed & link code/views by embeds/shares of embeds/embeds last viewed, etc.) and expiration rules made available to Vibe Accounts within Content Management interface at Channel Level
4) Parsing and saving of Publisher and Publish Date from source feeds, for access and use in the overlay displayed prior to embed play.
C) Auto-Play
   1) No auto-play upon page open in browser; Embedded Titles will play individual Title to completion of Title when play is clicked on the Embedded Player.
   2) Overlay as in 1A4 presented to user prior to and after completion of play.
   3) Auto-Buffer Rules
      One Pyro.TV embed flash player within a web page
         Auto-buffer the first title to be played
      More than one Pyro.TV embed flash player within a page:
         Auto-buffer the first title, only; ensure the remaining embed flash players do not attempt to auto-buffer.
      4) Missing Content Rules
         If Embedded Title has been expired in Pyro.TV, watermark/overlay presented to user: “This Pyro.TV Video Title has expired (Second Line) “Want More Titles Like This? (Third Line) [Click Here!—button]
         Click Here button links back to Pyro.TV as “Powered By Pyro” in 1A4
         If Channel still exists, present user with Pyro.TV page at Video Player window with latest Title in Channel, View Titles Content in Tab area
         If Channel does not exist, present user with default Pyro.TV page
D) Access/Use flow
   1) Pyro.TV (Partner TV) Video Player Page
      A) Embed/Link Code Link
         1) Updated for Option to Share Title or Share Channel
         2) IE7 Copy to Clipboard Button
      B) Send To Friend
         1) Updated for Option to Share Title or Share Channel
   2) Embedded Title Players
      A) Share Icon (bottom right of Player)
         1) Option to Share Title or Share Channel
         2) Embed/Link Code and Send to Friend presented in same use flow
         3) Custom Messaging link for Optional messaging on Send to Friend
   3) Embedded Channel Players
   A) Share Icon (bottom right of Player)
      1) Option to Share Title or Share Channel
      2) Embed/Link Code and Send to Friend presented in same use flow
      3) Custom Messaging link for Optional messaging on Send to Friend
   4) Embedded My Channels Players
      A) Share Icon (bottom right of Player)
         1) Option to Share Title or Share Channel
         2) Embed/Link Code and Send to Friend presented in same use flow
         3) Custom Messaging link for Optional messaging on Send to Friend
   5) Search API (see Search API for confirming details)
      A) Title Flash Player
         1) Presented within each Title enclosure
      B) Embed/Link Code
         2) Presented within each Title enclosure

### 2) Embeddable Channel Flash Player

A) Skinning
   1) No partner TV or content partner skinning
   2) Pyro.TV embeddable player skin common across all Partner TV implementations
   3) Title Description, Channel Title, Channel Logo shown within Mouseover Title Bar feature, when video is playing.
   4) Prior to video play, present slightly transparent overlay of video window showing first frame of video, to include:
      Channel Logo, clickable back to “View Titles” in Tab Window, playing first video in channel in Video Player Window
      Channel Title
      “By [Publisher/Author]”
      “[Title Description]-[Published Date]”
      “Click to Play Video”, clickable to start video title playing
      “Click to see more titles from this channel”, clickable back to “View Titles” in Tab Window, playing first video in channel in Video Player Window
      “Powered by [Pyro.TV logo]”, clickable back to Pyro.TV site at http://www.pyro.tv/
B) Backend
   1) Embedded Channel Players will display current content of channel as cached by VSG
   2) Title Expiration Rules: Embedded Channel Player Titles expire as VSG content updated from source feeds
   3) Embedded Channel data (channel/embed & link code/views by embeds/shares of embeds/embeds last viewed, etc.) available to Vibe accounts within Content Management interface at Channel Level
   4) Parsing and saving of Publisher and Publish Date from source feeds, for access and use in the overlay displayed prior to embed play.
C) Auto-Play
   1) No auto-play upon web page open in browser; Embedded Channels will auto-play initial Title from default channel through remainder of Titles in the Channel, and auto-loop back through the first title thereafter when play is clicked in the Embedded Channels player.
   2) Overlay as in 2A4 presented to user prior to play.
   3) See auto-play rules for Channel pull-downs in screenshots
   4) Auto-Buffer Rules
      One Pyro.TV embed flash player within a web page
         Auto-buffer the first title to be played
      More than one Pyro.TV embed flash player within a page:
         Auto-buffer the first title, only; ensure the remaining embed flash players do not attempt to auto-buffer.
   5) Missing Content Rules
      If Embedded Channel has been deleted in Pyro.TV, overlay presented to user: “This Pyro.TV Video Channel has expired (Second Line) “Want More Channels Like This? (Third Line) [Click Here!—button]
      Click Here button links back to Pyro.TV as “Powered By Pyro” in 2A4
      If Network still exists, present user with Pyro.TV page at Video Player window with latest Title in First Channel from same Network, View Titles Content in Tab area
      If Network does not exist, present user with default Pyro.TV page
D) Access/Use flow
   1) Pyro.TV (Partner TV) Video Player Page
      A) Embed/Link Code Link
         1) Updated for Option to Share Title or Share Channel
         2) IE7 Copy to Clipboard Button
      B) Send To Friend
         1) Updated for Option to Share Title or Share Channel
   2) Pyro.TV (Partner TV) Channel Info/View Titles Page
      A) Embed/Link Code Link
         1) Include Link in Channel Info Sidebar
         2) IE7 Copy to Clipboard Button
         3) Share Channel Flow, Only
      B) Send To Friend
         1) Include Link in Channel Info Sidebar
         2) Share Channel Flow, Only
   3) Pyro.TV (Partner TV) Created Channels Tab
      A) Embed/Link Code Link
         1) Include Link in Created Channel Info Sidebar
         2) IE7 Copy to Clipboard Button
         3) Share Channel Flow, Only
      B) Send To Friend
         1) Include Link in Created Channel Info Sidebar
         2) Share Channel Flow, Only
   4) Embedded Title Players
      A) Share Icon (bottom right of Player)
         1) Option to Share Title or Share Channel
         2) Embed/Link Code and Send to Friend presented in same use flow
         3) Custom Messaging link for Optional messaging on Send to Friend
   5) Embedded Channel Players
      A) Share Icon (bottom right of Player)
         1) Option to Share Title or Share Channel
         2) Embed/Link Code and Send to Friend presented in same use flow
         3) Custom Messaging link for Optional messaging on Send to Friend
   6) Embedded My Channels Players
      A) Share Icon (bottom right of Player)
         1) Option to Share Title or Share Channel
         2) Embed/Link Code and Send to Friend presented in same use flow
         3) Custom Messaging link for Optional messaging on Send to Friend
   7) Search API (see Search API for confirming details)
      A) Title Flash Player
         1) Presented within each Title enclosure
      B) Embed/Link Code
         2) Presented within each Title enclosure

### 3) Embeddable My Channels Flash Player

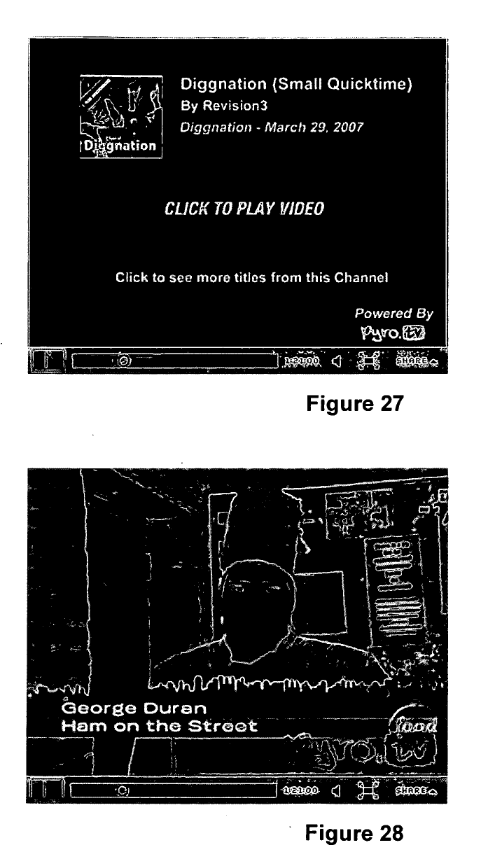

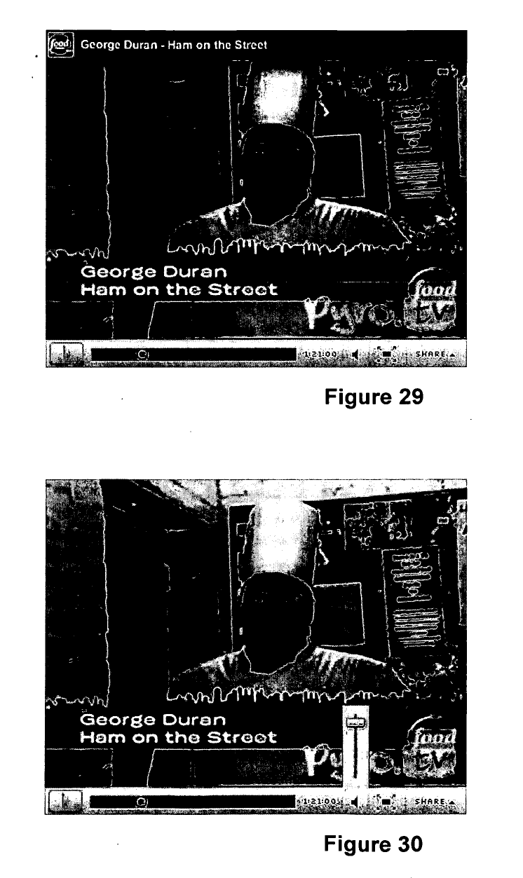

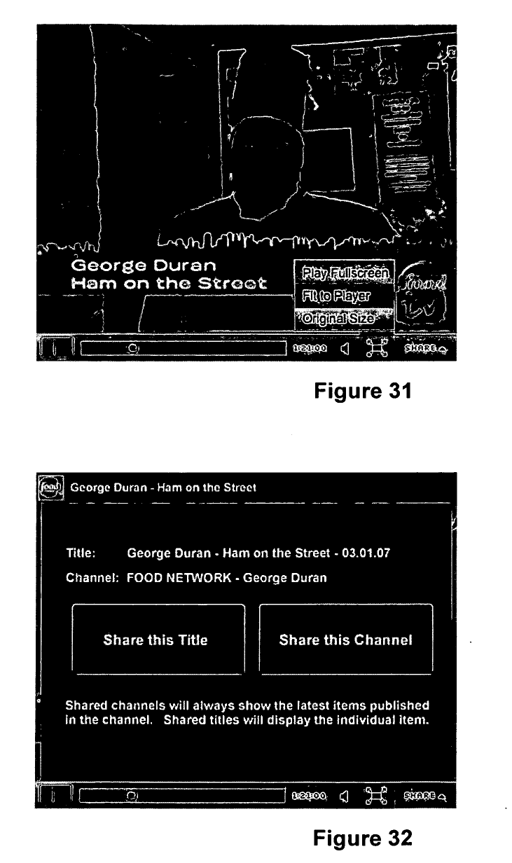

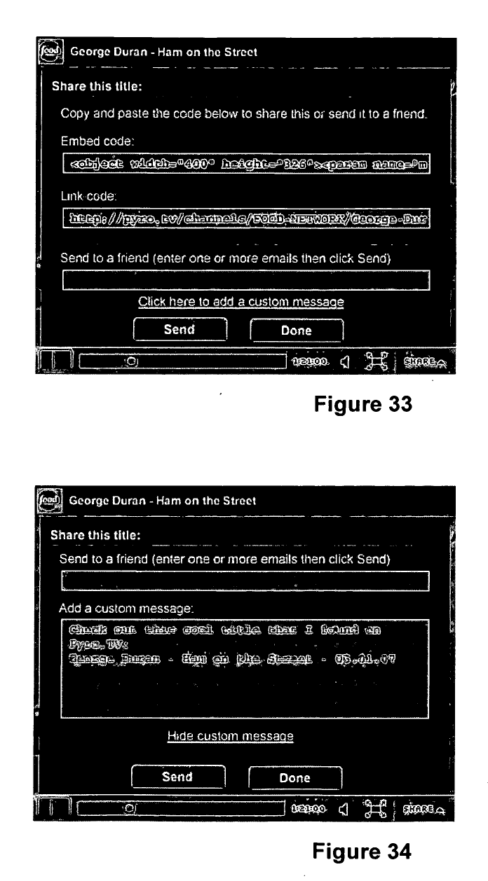

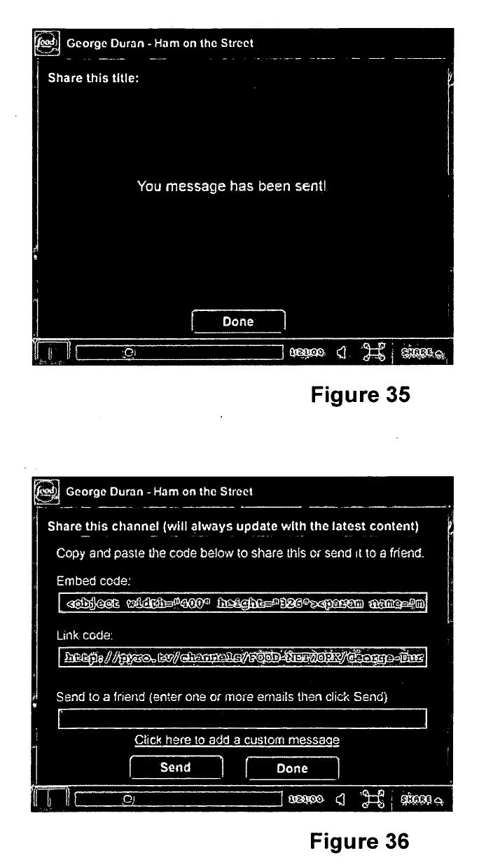

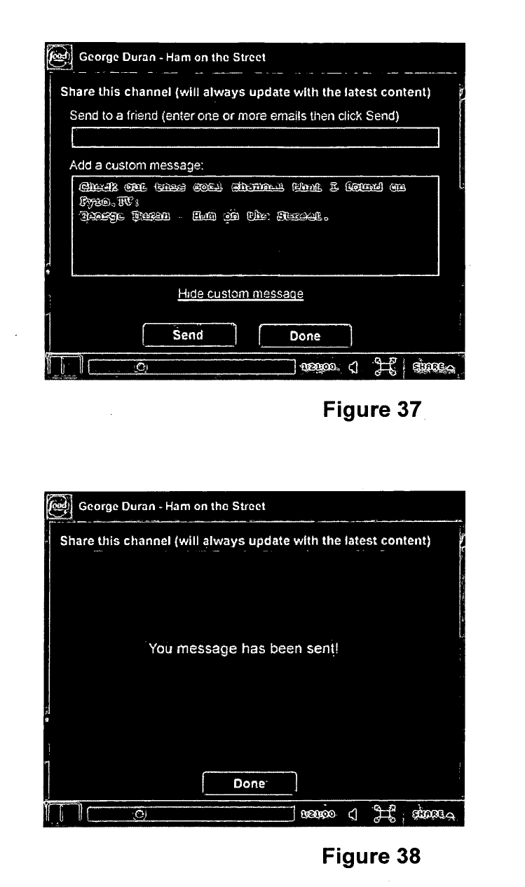

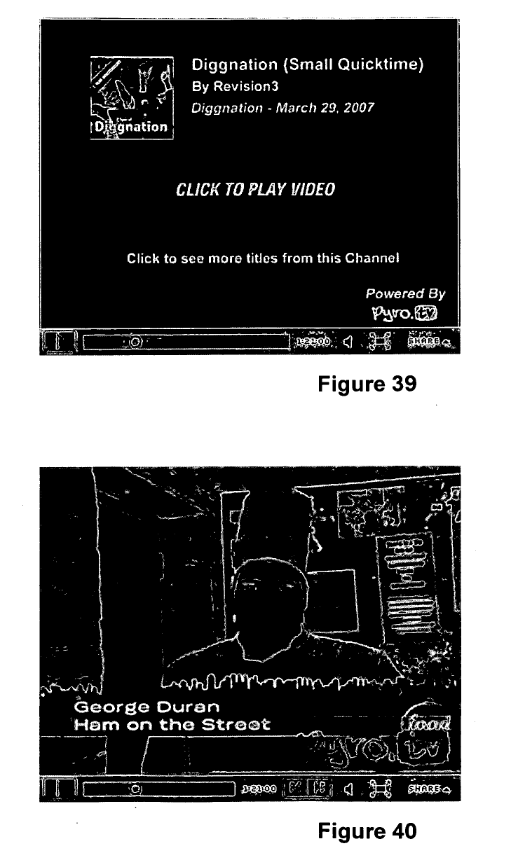

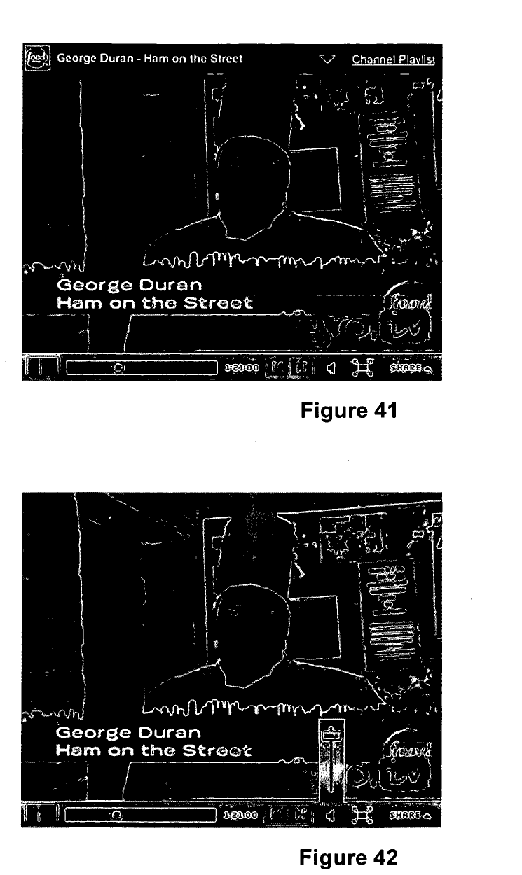

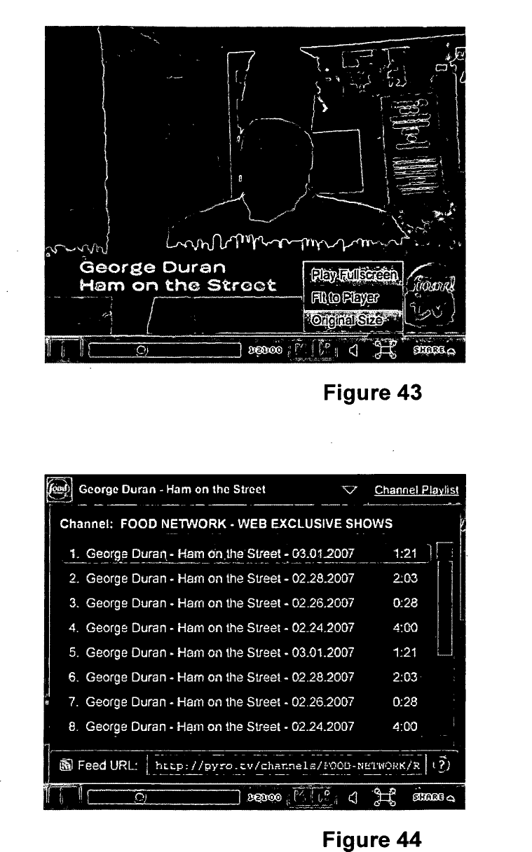

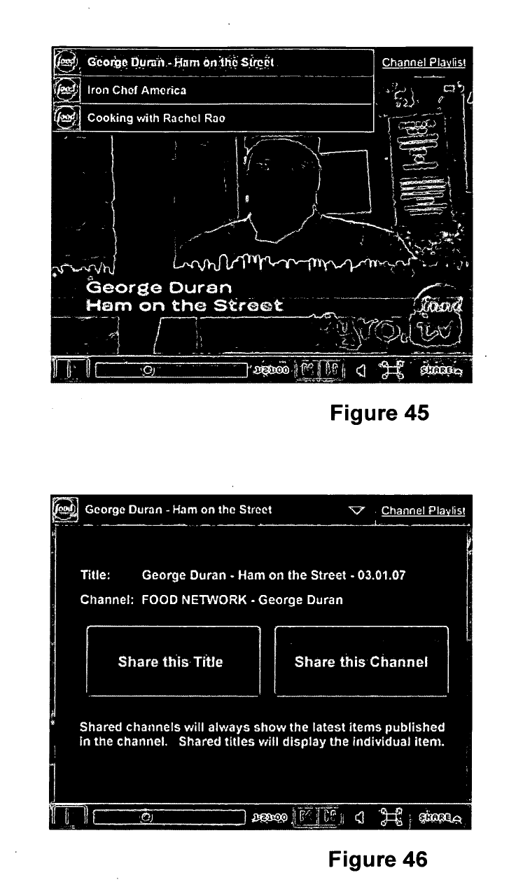

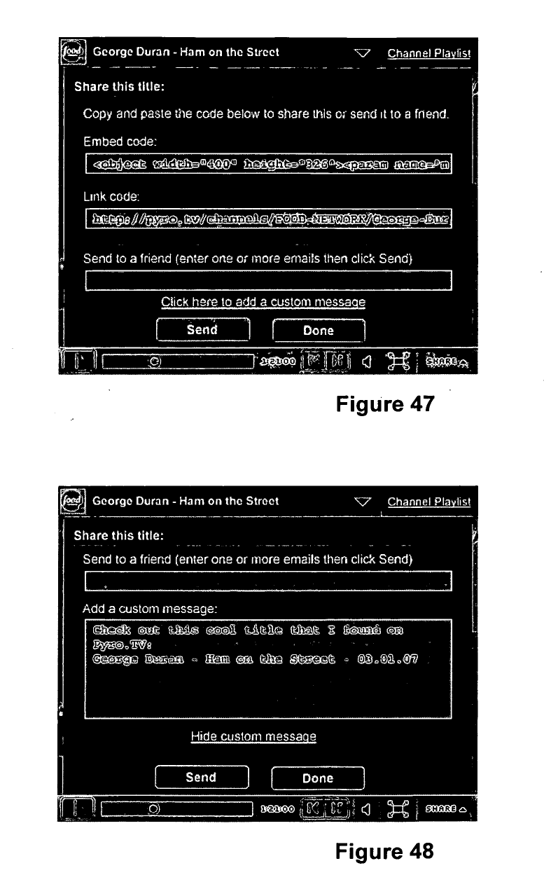

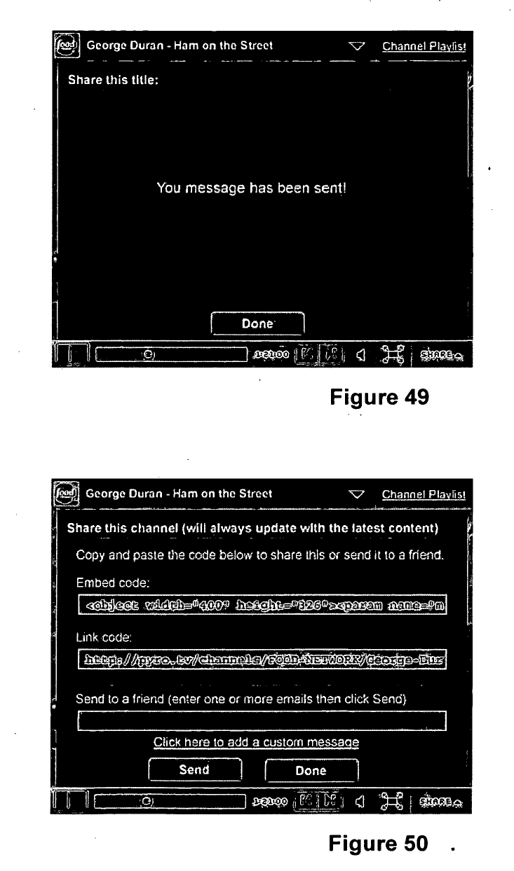

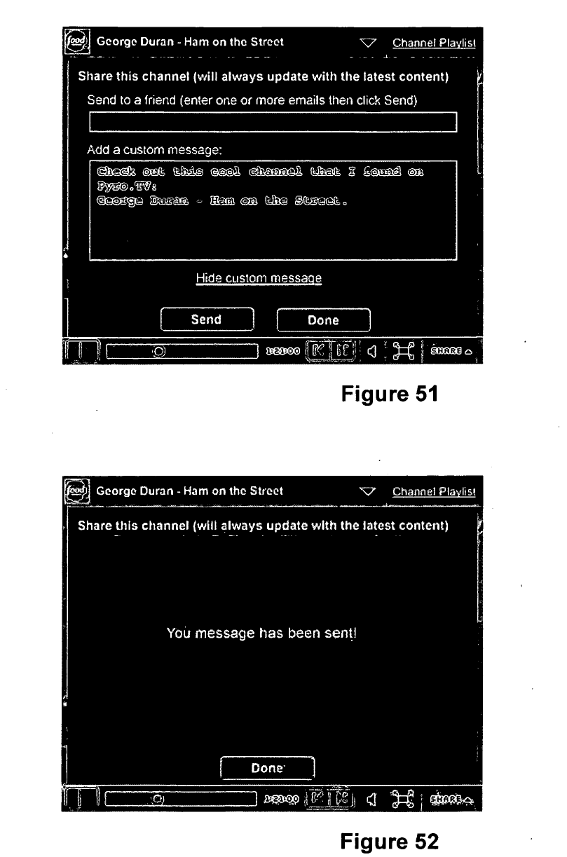

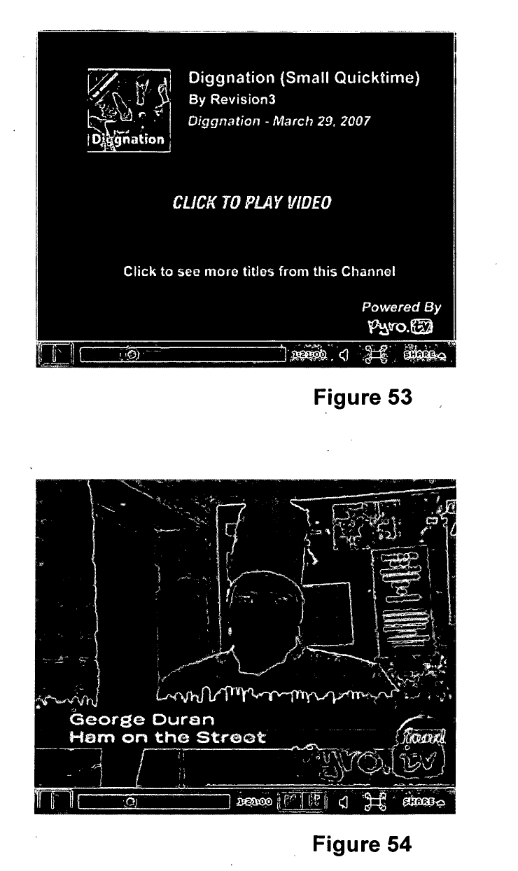

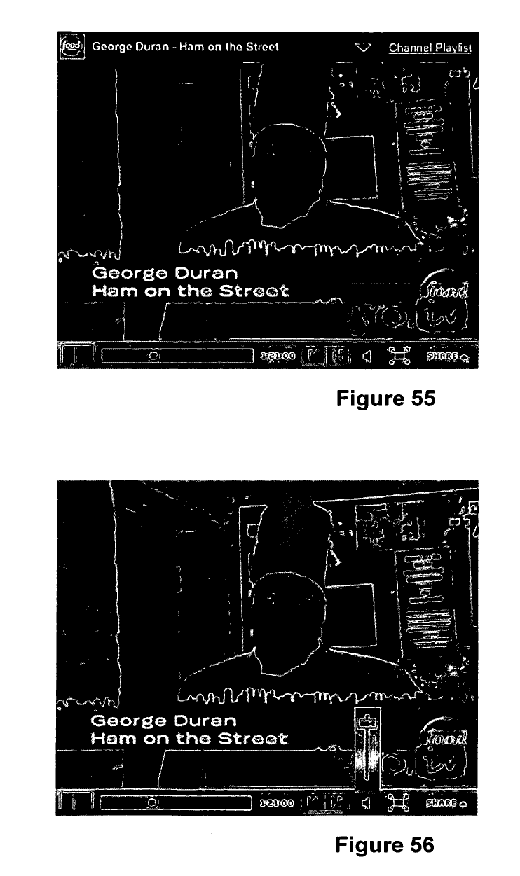

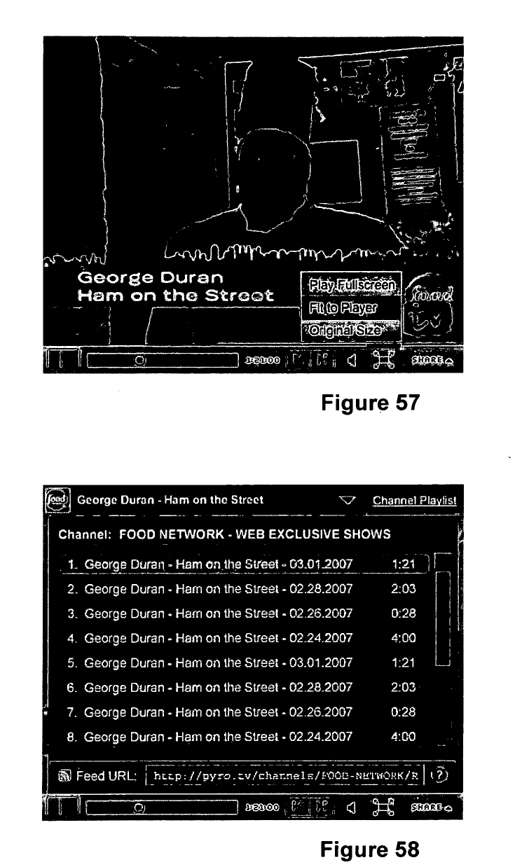

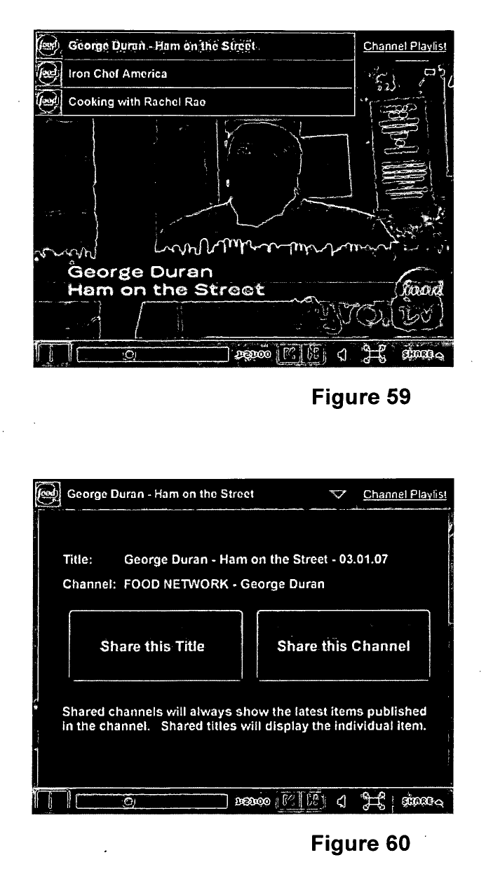

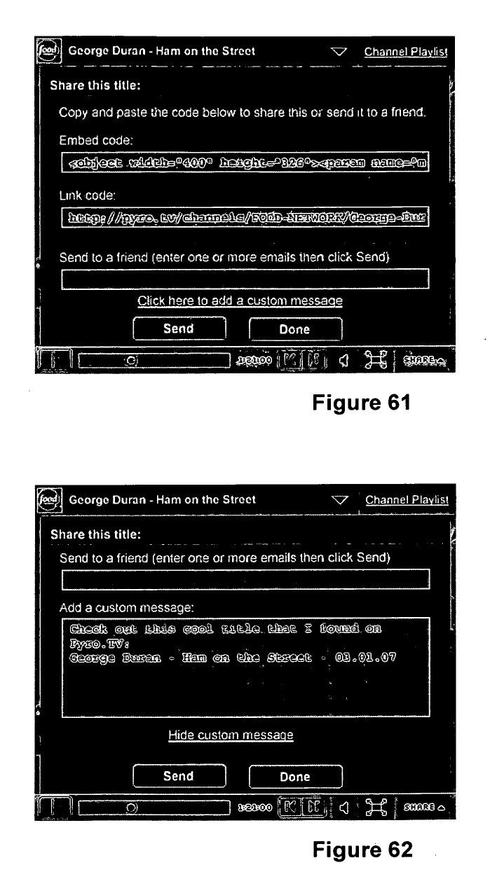

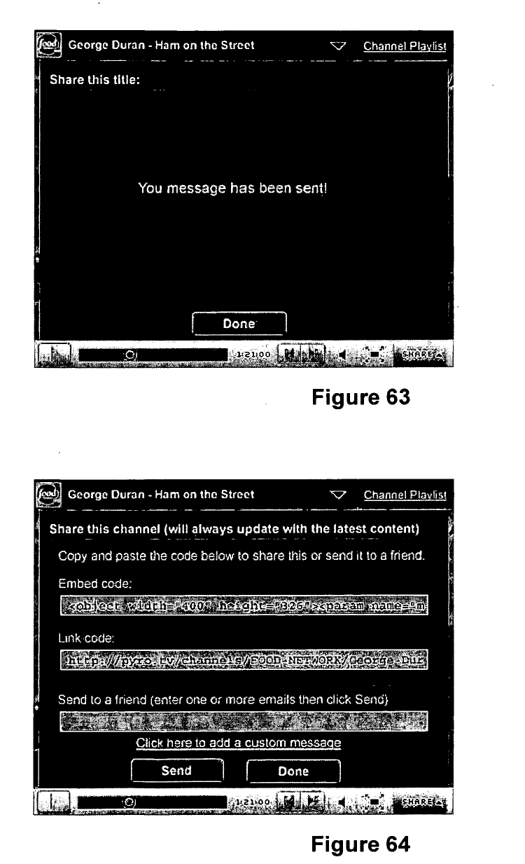

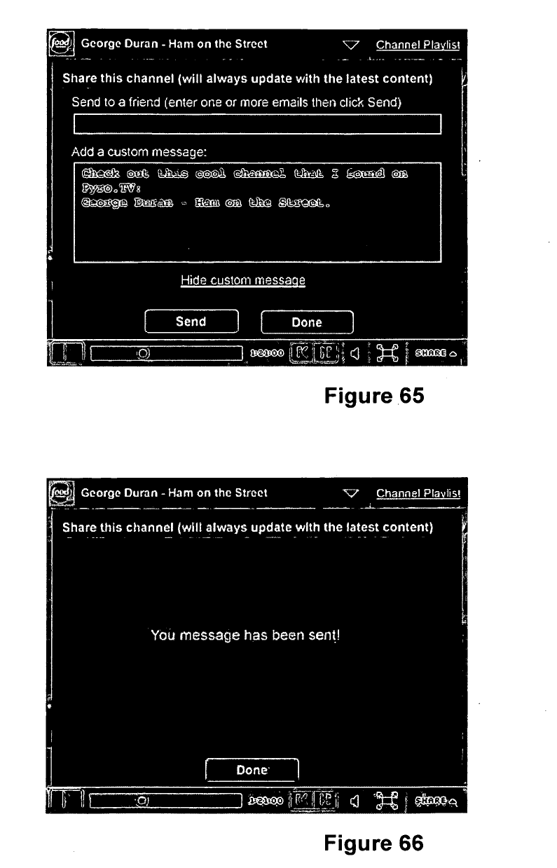

A) Skinning
   1) No partner TV or content partner skinning
   2) Pyro.TV embeddable player skin common across all Partner TV implementations
   3) Title Description, Channel Title and Channel Logo shown within Mouseover Title Bar feature, when video is playing.
   Prior to video play, present slightly transparent overlay of video window showing first frame of video, to include:
      Channel Logo, clickable back to “View Titles” in Tab Window, playing first video in channel in Video Player Window
      Channel Title
      “By [Publisher/Author]”
      “[Title Description]-[Published Date]”
      “Click to Play Video”, clickable to start video title playing
      “Click to see more titles from this channel”, clickable back to “View Titles” in Tab Window, playing first video in channel in Video Player Window
      “Powered by [Pyro.TV logo]”, clickable back to Pyro.TV site at http://www.pyro.tv/
B) Backend
   1) Embedded My Channels Players will display current content of saved channels as cached by VSG
   2) Title Expiration Rules: Embedded Channel Player Titles expire as VSG content updated from source feeds
   3) Embedded My Channels data (user/embed & link code/views by embeds/shares of embeds/embeds last viewed, etc.) made available to Vibe accounts within Content Management interface at Channel Level
   4) Parsing and saving of Publisher and Publish Date from source feeds, for access and use in the overlay displayed prior to embed play.
C) Auto-Play/Auto-Buffer
   1) No auto-play upon web page open in browser; Embedded My Channels will auto-play initial Title from default channel of My Channels through remainder of Titles in initial Channel, and auto-loop back through the first title thereafter when play is clicked in the Embedded My Channels player.
   2) Overlay as in 3A4 presented to user prior to play.
   3) See auto-play rules for Channel pull-downs in screenshots
   4) Auto-Buffer Rules
      One Pyro.TV embed flash player within a web page
         Auto-buffer the first title to be played
      More than one Pyro.TV embed flash player within a page:
         Auto-buffer the first title, only; ensure the remaining embed flash players do not attempt to auto-buffer.
   5) Missing Content Rules
      If user account has been deleted in Pyro.TV, watermark/overlay presented to user: “This Pyro.TV Account has expired (Second Line) “Want More Channels Like This? (Third Line) [Click Here!—button]
      Click Here button links back to Pyro.TV as Pyro Watermark in 1A4
D) Access/Use flow
   1) Pyro.TV (Partner TV) My Channels Tab
      A) Embed/Link Code Link
         1) Include Link in My Channels Info Sidebar
         2) IE7 Copy to Clipboard Button
         3) Share Channel Flow, Only
      B) Send To Friend
         1) Include Link in My Channels Info Sidebar
         2) Share Channel Flow, Only
   2) Embedded My Channels Players
      A) Share Icon (bottom right of Player)
         1) Option to Share Title or Share Channel
         2) Embed/Link Code and Send to Friend presented in same use flow
         3) Custom Messaging link for Optional messaging on Send to Friend
            FIG. 27 depicts an Embed Title Player—Prior to and After Title Play
Revised Overlay, per section 1A4 of Embed Title
   FIG. 28 depicts an Embed Title Player—Playing, No Mouseover
Revised look and feel: light chrome dashboard with borderless player
New Features: Mouseover, Volume Control, Re-sizing, Sharing
   FIG. 29 depicts an Embed Title Player—Playing, with Mouseover
Mouseover in any part of player window when playing (besides chrome dash) displays Channel logo, Title and Channel Description
Channel logo and title is clickable, links to Pyro.TV with same Title playing in Video Window, View Titles for its Channel in Tab area
   FIG. 30 depicts an Embed Title Player—Volume Control
Click on speaker icon reveals full-level volume control and current level (no mute)
   FIG. 31 depicts an Embed Title Player—Zoom Control
Click on sizing icon reveals options: Original Size (default), Fit to Player (for smaller/widescreen), Play Fullscreen
Play Fullscreen puts Flash player in new browser window/tab at maximum browser/tab size
   FIG. 32 depicts an Embed Title Player—Sharing Options
Upon sharing, video pauses until done; escape by re-clicking share icon
Both Embed Title and Embed Channel Players will provide consumers option to share the title viewed or entire channel of titles
Mouseover displays when Sharing (only location on chrome that does)
   FIG. 33 depicts an Embed Title Player—Share Title Options
Consumer shown title sharing options: Embed code, Link code and Send to Friend
Custom message listed as optional link
   FIG. 34 depicts an Embed Title Player—Share Title, Add Custom Message
User may enter custom message in addition to email list, comma or blank space delimited
Hide custom message returns user to the Share Title options
   FIG. 35 depicts an Embed Title Player—Share Title Message Confirmation
Done button returns user to video in progress (auto-play from pause)
Return to Sharing by clicking share icon in dash
   FIG. 36 depicts an Embed Title Player—Share Channel Options
Consumer shown channel sharing options: Embed code, Link code and Send to Friend
Custom message listed as optional link
   FIG. 37 depicts an Embed Title Player—Share Channel, Add Custom Message
User may enter custom message in addition to email list, comma or blank space delimited
Hide custom message returns user to the Share Channel options
   FIG. 38 depicts an Embed Title Player—Share Channel Message Confirmation
Done button returns user to video title in progress (auto-play from pause)
Return to Sharing by clicking share icon in dash
   A content player can also be configured as an Embed Title Player—Pyro.TV Video Player Window—Embed/Link Flow, with the following features:
Embed/Link Code link
Click pulls up Pyro.TV “chrome” pop-up with choice as in FIG. 32
Flows continue in “chrome” as in FIGS. 33 and 36, with no “send to friend”
   A content player can also be configured as an Embed Title Player—Pyro.TV Video Player Window—Send to Friend Flow, with the following features:
Send to Friend link
Click pulls up Pyro.TV “chrome” pop-up with choice as in FIG. 32
Flows continue in “chrome” as in current “send to friend” pop-up form, with no “embed link code”
   FIG. 39 depicts an Embed Channel Player—Prior to Play
Revised Overlay, per section 2A4 of Embed Channel
   FIG. 40 depicts an Embed Channel Player—Playing, with No Mouseover
Same look and feel and Embed Title Player:
   light chrome dashboard with borderless player
Same as Embed Title Player Features:
   Mouseover, Volume Control, Re-sizing, Sharing
Additional Embed Channel Player Features:
   Previous/Next Title Navigation,
   Channel Playlist,
   Network Channel Pulldown
Previous/Next Title Navigation
   New dashboard icons of “previous” (“|<”) and “next” (“>”)
   when clicked, advances player to the previous or next Title within the Channel
   Looping
      clicking “previous” when viewing First Title will advance to Last Title
      clicking “next” when viewing Last Title will advance to First Title
         FIG. 41 depicts an Embed Channel Player—Playing, with Mouseover
Mouseover in any part of player window (not chrome dash, except when sharing) displays Channel logo, Title and Channel Description (same as Embed Title Player)
Channel logo is clickable, links to Pyro.TV with same Title playing in Video Window, View Titles for its Channel in Tab area
In Embed Channel Player, Channel/Title Description is a pull down for selecting other channels from same network
In Embed Channel Player, Channel Playlist link is shown in mouseover to navigate to other titles by viewing Title Description
   FIG. 42 depicts an Embed Channel Player—Volume Control
Click on speaker icon reveals full-level volume control and current level (no mute)
   FIG. 43 depicts an Embed Channel Player—Zoom Control
Click on sizing icon reveals options: Original Size (default), Fit to Player (for smaller/widescreen), Play Fullscreen
Play Fullscreen puts Flash player in new browser window/tab at maximum browser/tab size
   FIG. 44 depicts an Embed Channel Player—Channel Title View
Click on Channel Playlist link displays
   scrolling list of titles within the channel
   feed URL for the Channel
   “?” link for FAQ on Feed URL
Click on Title
   plays individual Title
   re-sets auto-play loop to start with this title
      FIG. 45 depicts an Embed Channel Player—Network Channel Dropdown Navigation
Click on Channel/Title Description (aside from channel logo) opens a dropdown list
Dropdown list displays up to N Channels associated with Network
   (need to determine limits on display of channels in pull down)
Selecting Channel Y from within Channel X Embed Channel Player allows consumer to interact with Channel Y as if it were native to the Embed Channel X Player
   View Channel Y Titles
   Navigate Channel Y Titles
   Share
      Embed Title X Player from Channel Y
      Embed Channel Y Player
      Send to Friend for both
Selecting Channel Y from dropdown does NOT reset the default experience for current or future users: player will always default to the Embed Channel Player for that specific Channel initially chosen
   FIG. 46 depicts an Embed Channel Player—Sharing Options
Upon sharing, video pauses until done; escape by re-clicking share icon, selecting Channel Playlist or new Channel from Network Dropdown
Both Embed Title and Embed Channel Players will provide consumers option to share the title viewed or entire channel of titles
Mouseover displays when Sharing (only location on chrome that does)
   FIG. 47 depicts an Embed Channel Player—Share Title Options
Consumer shown title sharing options: Embed code, Link code and Send to Friend
Custom message listed as optional link
   FIG. 48 depicts an Embed Channel Player—Share Title, Add Custom Message
User may enter custom message in addition to email list, comma or blank space delimited
Hide custom message returns user to the Share Title options
   FIG. 49 depicts an Embed Channel Player—Share Title Message Confirmation
Done button returns user to video in progress (auto-play from pause)
Return to Sharing by clicking share icon in dash
   FIG. 50 depicts an Embed Channel Player—Share Channel Options
Consumer shown channel sharing options: Embed code, Link code and Send to Friend
Custom message listed as optional link
   FIG. 51 depicts an Embed Channel Player—Share Channel, Add Custom Message
User may enter custom message in addition to email list, comma or blank space delimited
Hide custom message returns user to the Share Channel options
   FIG. 52 depicts an Embed Channel Player—Share Channel Message Confirmation
Done button returns user to video title in progress (auto-play from pause)
Return to Sharing by clicking share icon in dash
   A content player can also be configured as an Embed Channel Player—Pyro.TV Video Player Window—Embed/Link Flow, with the following features:
Embed/Link Code link
Click pulls up Pyro.TV “chrome” pop-up with choice as in FIG. 46
Flows continue in “chrome” as in FIGS. 47 and 50, with no “send to friend”
   A content player can also be configured as an Embed Channel Player—Pyro.TV Video Player Window—Send to Friend Flow, with the following features:
Send to Friend link
Click pulls up Pyro.TV “chrome” pop-up with choice as in FIG. 46
Flows continue in “chrome” as in current “send to friend” pop-up form, with no “embed link code”
   A content player can also be configured as an Embed Channel Player—Pyro.TV Channel Info/View Titles—Embed/Link Flow, with the following features:
Embed/Link Code link
Click pulls up “chrome” of current embed/link pop-up, with no “send to friend”
   A content player can also be configured as an Embed Channel Player—Pyro.TV Channel Info/View Titles—Send to Friend Flow, with the following features:
Send to Friend link
Click pulls up current Pyro.TV “chrome” “send to friend” pop-up form, with no “embed link code”
   A content player can also be configured as an Embed Channel Player—Pyro.TV Created Channels—Embed/Link Flow, with the following features:
Embed/Link Code link
Click pulls up “chrome” of current embed/link pop-up, with no “send to friend”
   A content player can also be configured as an Embed Channel Player—Pyro.TV Created Channel—Send to Friend Flow, with the following features:
Send to Friend link
Click pulls up current Pyro.TV “chrome” “send to friend” pop-up form, with no “embed link code”
   FIG. 53 depicts an Embed My Channels Player—Prior to Play
Revised Overlay, per section 3A4 of Embed My Channels
   FIG. 54 depicts an Embed My Channels Player—Playing, No Mouseover
Same look and feel and Embed Title Player:
   light chrome dashboard with borderless player
Same as Embed Title Player Features:
   Mouseover, Volume Control, Re-sizing, Sharing
Additional Embed Channel Player Features:
   Previous/Next Title Navigation,
   Channel Playlist,
   My Channels Pulldown
Previous/Next Title Navigation
   New dashboard icons of “previous” (“|<”) and “next” (“>”)
   when clicked, advances player to the previous or next Title within the Channel
   Looping
      clicking “previous” when viewing First Title will advance to Last Title
      clicking “next” when viewing Last Title will advance to First Title
         FIG. 55 depicts an Embed My Channels Player—Playing, with Mouseover
Mouseover in any part of player window (not chrome dash, except when sharing) displays Channel logo, Title and Channel Description (same as Embed Title Player)
Channel logo and title is clickable, links to Pyro.TV with same Title playing in Video Window, View Titles for its Channel in Tab area
In Embed Channel Player, Channel/Title Description is a pull down for selecting other channels from same network
In Embed Channel Player, Channel Playlist link is shown in mouseover to navigate to other titles by viewing Title Description
   FIG. 56 depicts an Embed My Channels Player—Volume Control
Click on speaker icon reveals full-level volume control and current level (no mute)
   FIG. 57 depicts an Embed My Channels Player—Zoom Control
Click on sizing icon reveals options: Original Size (default), Fit to Player (for smaller/widescreen), Play Fullscreen
Play Fullscreen puts Flash player in new browser window/tab at maximum browser/tab size
   FIG. 58 depicts an Embed My Channels Player—Channel Title View
Click on Channel Playlist link displays
   scrolling list of titles within the channel
   feed URL for the Channel
   “?” link for FAQ on Feed URL
Click on Title
   Plays individual title
   Resets auto-play loop to start with this title
      FIG. 59 depicts an Embed My Channels Player—My Channels Dropdown Navigation. However, it should be noted that the dropdown navigation of FIG. 59 can be replaced with a pulldown showing different channels in My Channels)
Click on Channel/Title Description (aside from channel logo) opens a dropdown list
Dropdown list displays up to N Channels associated with My Channels
   (need to determine limits on display of channels in pull down)
   (if over the limit, provide link back to Pyro.TV site to public user profile of My Channels)
Selecting Channel Y from within Embed My Channels Player allows consumer to interact with Channel Y as if it were the default channel in the Embed My Channels Player
   View Channel Y Titles
   Navigate Channel Y Titles
   Share
      Embed Title X Player from Channel Y
      Embed Channel Y Player
      Send to Friend for both
Selecting Channel Y from dropdown does NOT reset the default experience for current or future users: player will always default to the Embed My Channel Player default content (assumed the First Channel in My Channels, or by configurable order in future enhancements)
   FIG. 60 depicts an Embed My Channels Player—Sharing Options
Upon sharing, video pauses until done; escape by re-clicking share icon, selecting Channel Playlist or new Channel from Network Dropdown
Embed Title, Embed Channel and Embed My Channels will provide consumers option to share the title viewed or entire channel of title viewed
Mouseover displays permanently when Sharing (only chrome that does)
   FIG. 61 depicts an Embed My Channels Player—Share Title Options
Consumer shown title sharing options: Embed code, Link code and Send to Friend
Custom message listed as optional link
   FIG. 62 depicts an Embed My Channels Player—Share Title, Add Custom Message
User may enter custom message in addition to email list, comma or blank space delimited
Hide custom message returns user to the Share Title options
   FIG. 63 depicts an Embed My Channels Player—Share Title Message Confirmation
Done button returns user to video in progress (auto-play from pause)
Return to Sharing by clicking share icon in dash
   FIG. 64 depicts an Embed My Channels Player—Share Channel Options
Consumer shown channel sharing options: Embed code, Link code and Send to Friend
Custom message listed as optional link
   FIG. 65 depicts an Embed My Channels Player—Share Channel, Add Custom Message
User may enter custom message in addition to email list, comma or blank space delimited
Hide custom message returns user to the Share Channel options
   FIG. 66 depicts an Embed My Channels Player—Share Channel Message Confirmation
Done button returns user to video title in progress (auto-play from pause)
Return to Sharing by clicking share icon in dash
   A content player can also be configured as an Embed My Channels Player—Pyro.TV Video My Channels Tab—Embed/Link Flow, with the following features:
Embed/Link Code link on sidebar of My Channels
Click pulls up Pyro.TV “chrome” pop-up of current Embed/Link code
   A content player can also be configured as an Embed My Channels Player—Pyro.TV Video My Channels Tab—Send to Friend Flow, with the following features:
Send to Friend link on sidebar of My Channels
Click pulls up Pyro.TV “chrome” pop-up with of current “Send to Friend”
Received email link sends recipient to People Profile page of individual user displaying associated My Channels

### APPENDIX C

### Pyro.TV Embed Player—Use Flows

### Content Notes, Exemplary Features

Hosted audio/video file content
Source content input by RSS Feed Enclosures, OPML aggregation lists of RSS Feeds or server upload of media content files to be associated with providers/channels
Transcoding of video content to common browser plug-in media format (e.g. Flash) from source content file types

### Exemplary Player Notes, Features

Segmented implementation of Title, Channel or Playlist (i.e./e.g. My Channels) Players
User configurable playlist/favorites list drives Channel and Title content display
Real-time playlist/favorites list access and configuration in player use flows
Access to both Free and Premium (paid) Content
Authentication of users in player context, in order to access personal content playlist/favorites list, transact for Premium (paid) content and reach other account-only features
Completion of transactions via player
   Purchase of content
   Playlist configuration
Web-based player, only requires browser plug-in for player (Flash)
Access to multiple channels across playlist/favorites list,
Access to multiple titles within channels
Automatic content update from Server Source(s), yields updates for new page/data requests from Embed Players

### Exemplary Consumption Notes, Features

Web page embeddable player code, for manual or 3^{rd} Party API posting
Browser desktop shortcut to player URL's, for direct access
Browser bookmark of player URL's, for direct access
   Pyro.TV Embed Player—Use Flow, Server Calls (with Reference to FIG. 17):
Web Page (B) containing a Embed Player Object (C) is requested by a Browser (A)
Embed Player Object (C) code within web page references Media Title/Channel/Profile URL within its configuration and display parameters
[1] Embed Player Object (C) requests Media Title/Channel/Profile URL from Web Service (D)
[2, 3] Based on this request from the Embed Player Object (C), Web Service (D) dynamically provides appropriate Content Meta-Data (E) from the Content Database (K) to Embed Player (C).
Embed Player (C) utilizes the Content Meta-Data (E) in order to
   Display initial, interstitial, and error overlay meta-data within the Embed Player Object
   Display and utilize Share overlay meta-data within the Embed Player Object Share use flows (e.g. “Get Player”, “Send to Friend”, etc.)
   Display meta-data in actionable functions (e.g. Title icons and meta-data display upon player Mouseover; channel playlist) within the Embed Player Object
   Reference individual title audio/video content file locations for progressive download/streaming.
[4] As any individual audio/video content is queued for load and play based on auto-play behavior or user navigation within the player, Embed Player Object (C) makes request to Pyro.TV Service (D) to access the status parameters of the content [5] using a valid Session Cookie parameter, if available (H):
   Is the content to be queued Free or Premium?
   If Premium, is the user account associated with the Session Cookie currently subscribed?
   If currently subscribed, is the user account associated with the Session Cookie currently active for payment on the Premium subscription
[6] If either queued content is Free, or user is logged in/subscribed/payment up-to-date for Premium content, Embed Player (C) makes a request to Pyro.TV Service (D) to begin progressive download and/or streaming from the Content Media File Service (F), [7, 8], from which the Embed Player (C) begins to play the content.
[9] If user is not logged-in for queued Premium content, the Embed Player Object will display a login screen, which when username/password entry is submitted, makes a request to Pyro.TV Web Service (D) to authenticate the user via the Authentication Service (G) [10].
[11] If authentication is successful using submitted credentials, Session Cookie (H) is set in the Browser (A), which is available to the Embed Player (C) for subsequent requests to the Web Service (D) [12].
Once the Session Cookie (H) is set, steps [4, 5], [6, 7, 8] are repeated by the Embed Player (C) for the queued content.
[13] If authentication is unsuccessful, Web Service (D) returns parameters to the Embed Player (C) for error messaging/re-entry of credentials, using steps [9, 10, 11, 12].
[14] If successfully authenticated in [9, 10, 11, 12], with subsequent receipt of content meta-data in [4, 5], and request in [6] to start progressive download/streaming, but user subscription to queued Premium content is not currently active, Web Service (D) returns parameters to the Embed Player (C) for error messaging/entry of payment service information.

What is claimed is:

1. A computer-readable medium for playing content, the computer-readable medium comprising:
software code resident on the computer-readable medium, wherein the software code is executable by a processor for displaying and operating a web browser-based content player, the content player having a plurality of user-selectable channels, each channel comprising at least one title that is user-selectable for playback from within the player.

2. The computer-readable medium of claim 1 wherein the content player is configured to allow a user to navigate among the plurality of channels and the plurality of titles from within the player.

3. The computer-readable medium of claim 1 wherein the content player is configured to allow a user to follow a protocol from within the player for accessing at least one selected from the group consisting of a premium channel and a premium title.

4. The computer-readable medium of claim 1 wherein the content player is configured such that its channel lineup and/or title playlist is user-configurable from within the player.

5. The computer-readable medium of claim 1 wherein the content player is embeddable.

6. The computer-readable medium of claim 5 wherein the content player is embeddable on at least one selected from the group consisting of (1) a full player basis, (2) a channel-by-channel basis, and (3) a title-by-title basis.

7. An apparatus for playing content, the apparatus comprising:
a computer configured with a web browser, the web browser configured to display a web page that includes a web browser-based content player, the content player having a plurality of user-selectable channels, each channel comprising at least one title that is user-selectable for playback from within the player.

8. The apparatus of claim 7 wherein the content player is configured to allow a user to navigate among the plurality of channels and the plurality of titles from within the player.

9. The apparatus of claim 7 wherein the content player is configured to allow a user to follow a protocol from within the player for accessing at least one selected from the group consisting of a premium channel and a premium title.

10. The apparatus of claim 7 wherein the content player is configured such that its channel lineup and/or title playlist is user-configurable from within the player.

11. The apparatus of claim 7 wherein the content player is embeddable.

12. The apparatus of claim 11 wherein the content player is embeddable on at least one selected from the group consisting of (1) a full player basis, (2) a channel-by-channel basis, and (3) a title-by-title basis.

13. A method comprising:
providing a web browser-based content player, the content player having a plurality of user-selectable channels, each channel comprising at least one title that is user-selectable for playback from within the player.

14. The method of claim 13 wherein the content player is configured to allow a user to navigate among the plurality of channels and the plurality of titles from within the player.

15. The method of claim 13 wherein the content player is configured to allow a user to follow a protocol from within the player for accessing at least one selected from the group consisting of a premium channel and a premium title.

16. The method of claim 13 wherein the content player is configured such that its channel lineup and/or title playlist is user-configurable from within the player.

17. The method of claim 13 wherein the content player is embeddable.

18. The method of claim 17 wherein the content player is embeddable on at least one selected from the group consisting of (1) a full player basis, (2) a channel-by-channel basis, and (3) a title-by-title basis.

19. An apparatus for providing content to a content player, the apparatus comprising:
a server in communication with a content player via a network, wherein the server is configured to (1) receive a request for content from the content player, and (2) provide content to the content player in response to the request;
wherein the provided content comprises at least one channel and each channel comprises at least one playlist.

20. The apparatus of claim 19 wherein the provided content comprises a premium channel, and wherein the server is configured to receive access information before providing the premium content.

21. The apparatus of claim 19 wherein the server is further configured to:
receive content from a content source via the network;
automatically update the playlists for each channel in the content player in response to the received content.

22. The apparatus of claim 19 wherein the server is further configured to:
(1) receive a request to modify the content titles associated with a channel;
(2) modify the channel in response to the request.
